(19) United States
(12) Patent Application Publication
(10) Pub. No.: US 2007/0127148 A1
(43) Pub. Date: Jun. 7, 2007

(54) Apparatus and method for detecting contact between head and recording medium, and method for manufacturing head

(75) Inventors: Toru Yokohata, Kawasaki (JP); Takeshi Iwase, Kawasaki (JP); Takahisa Ueno, Kawasaki (JP); Seigo Igaki, Kawasaki (JP); Takahiro Imamura, Kawasaki (JP); Tohru Fujimaki, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/523,645

(22) Filed: Sep. 20, 2006

Related U.S. Application Data
(63) Continuation-in-part of application No. 11/387,064, filed on Mar. 23, 2006.

(30) Foreign Application Priority Data
Dec. 1, 2005 (JP) 2005-348356
Apr. 12, 2006 (JP) 2006-110212

(51) Int. Cl. G11B 27/36; G11B 21/02

(52) U.S. Cl. 360/31; 360/75

(57) ABSTRACT

In a contact detecting apparatus that detects contact of a head with a recording medium, a signal writing unit writes onto the recording medium, a signal that includes at least one predetermined frequency component; and a contact detecting unit detects the contact of the head with the recording medium based on an amplitude of the predetermined frequency component, by reading the signal written on the recording medium while changing a spacing between the head and the recording medium.

### BACKGROUND OF THE INVENTION

1. Field of the Invention

The present invention relates to a technology for detecting physical contact between a head and a recording medium.

2. Description of the Related Art

In magnetic storage devices (hard disks) and testing devices for testing magnetic recording (testers), there is a requirement that the spacing between the head that reads data from or writes data on a recording medium and the recording medium is as narrow as possible to enable high-density recording. The spacing between the head and the recording medium is extremely small, i.e., of the order of thirty times the diameter of an average-sized atom.

However, if the spacing is too narrow, there is a possibility that the head makes a physical contact with the recording medium and slides on the recording medium. A contact between the head and the recording medium causes various problems such as damage of the head and/or the recording medium, wrong positioning of the head, and reading of wrong data. Therefore, the spacing needs to be set adequate to avoid contacts between the head and the recording medium. Detection of contact between the head and the recording medium becomes very important in order to set the adequate spacing. There have been proposed various techniques to detect contact between the head and the recording medium.

Japanese Examined Patent Application Publication Nos. 7-1618 discloses detecting contact between a head and a recording medium by monitoring the changes in the read signal, whose magnitude is proportional to flying height of a head above a recording medium, with respect to the rotation speed of the recording medium. In other words, when the head contacts with the recording medium, the flying height becomes minimal and does not change any more; that is, the magnitude of the read signal does not change any more after the head has contacted the recording medium.

Japanese Examined Patent Application Publication No. 7-70185 discloses a method for separating a modulation component in a read signal to identify defects on the surface of a recording medium. When a head slider is disturbed due to defects on the surface of a recording medium, a frequency modulation component due to the air bearing disturbance is superimposed on the read signal in addition to a write signal frequency component, which is a normal component in the read signal. Because the frequency of the write signal frequency component is approximately one thousand times higher than the frequency of the modulation component, the modulation component can be separated easily using a relatively simple circuit. The publication thus discloses the method for detecting defects on the surface of a recording medium or the contact between a head slider and a recording medium.

However, as rotation speed of a recording medium reduces, the degree of changes in an actual read signal tends to gradually decrease and become closer and closer to zero. It is therefore extremely difficult with the method disclosed in the Japanese Examined Patent Application Publication No. 7-1618 to judge whether the head is in or out of contact with the recording medium.

FIG. 28 is a graph for explaining the relationship between rotational speed of a recording medium and the spacing between a head and the recording medium (i.e., flying height of a head slider) according to the Japanese Examined Patent Application Publication No. 7-1618. The vertical axis represents the flying height of the head slider estimated from the magnitude of a read signal, and the horizontal axis represents the rotation speed of the recording medium. The magnitude of the read signal is inversely proportional to the spacing. It is clear from the graph that, as the rotation speed reduces, the degree of changes in the read signal gradually decreases and becomes closer to zero.

The problem according to the method disclosed in the Japanese Examined Patent Application Publication No. 7-70185, which is to detect contact between the head and the medium by extracting the modulation component due to the air bearing disturbances from the signal is that it is extremely difficult to judge whether the head is in or out of contact with the medium when there are defects on the surface of the medium.

According to the method disclosed in this publication, once the head has made contact with a rather large defect, it is regarded that there was contact. However, there are actually some cases where the same defect is never detected again in a test performed immediately after the first contact. This kind of situation is experienced when fine dust on the medium is detected as a defect, but the dust is flicked off the medium by shock at the time of the detection and completely removed from the medium. In other words, because the sensitivity level of contact detection with defects and the like is too high, it is extremely difficult to judge whether the head is in or out of contact with the medium, from an aspect in which the influence of dust and defects is eliminated.

Thus, there is a need of a technology that can reliably and surely detect contact of a head with a recording medium.

### SUMMARY OF THE INVENTION

It is an object of the present invention to at least partially solve the problems in the conventional technology.

According to an aspect of the present invention, a contact detecting apparatus that detects contact of a head with a recording medium includes a signal writing unit that writes onto the recording medium, a signal that includes at least one predetermined frequency component; and a contact detecting unit that detects the contact of the head with the recording medium based on an amplitude of the predetermined frequency component, by reading the signal written on the recording medium while changing a spacing between the head and the recording medium, and generates a detection result.

According to another aspect of the present invention, a method for detecting contact of a head with a recording medium includes writing onto the recording medium, a signal that includes at least one predetermined frequency component; and detecting the contact of the head with the recording medium based on an amplitude of the predetermined frequency component, by reading the signal written on the recording medium while changing a spacing between the head and the recording medium, and generates a detection result.

According to another aspect of the present invention, a head manufacturing method includes detecting contact of a head with a recording medium. The detecting includes writing onto the recording medium, a signal that includes a predetermined frequency component; and detecting contact of the head with the recording medium based on an amplitude of the predetermined frequency component in the signal, by reading the signal written on the recording medium while changing a spacing between the head and the recording medium and generating a detection result.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining technical features of a magnetic recording apparatus according to a first embodiment of the present invention;

FIG. 2 is a detailed functional block diagram of the magnetic recording apparatus shown in FIG. 1;

FIG. 3 is a graph of a relationship between velocity of a magnetic disk and a first-order frequency component;

FIG. 4 is a cross-section of a head shown in FIG. 2;

FIG. 5 is a drawing for explaining a Wallace relationship equation;

FIG. 6 is another drawing for explaining the Wallace relationship equation;

FIG. 7 illustrates graphs for explaining a relationship between flying height of a head and velocity of a magnetic disk according to the first embodiment;

FIG. 8 illustrates graphs for explaining amplitude of a read signal in correspondence with the spacing between a head and a magnetic disk;

FIG. 9 illustrates graphs of results of trial calculations in which an amount of change in the spacing due to the air bearing is presumed to be 20 nm (nanometers), and the actual measured values of the read signal waveforms at a time of contact vibration occurrence;

FIG. 10 is a table showing results of calculations for the amplitude of a read signal with various write frequencies and various amounts of change in the spacing;

FIG. 11 is a schematic for explaining technical features of a magnetic recording apparatus according to a second embodiment of the present invention;

FIG. 12 is a detailed functional block diagram of the magnetic recording apparatus shown in FIG. 11;

FIG. 13 is a graph for explaining a relationship between velocity of a magnetic disk and complex amplitude values according to the second embodiment;

FIG. 14 illustrates graphs for explaining a relationship between flying height of a head and velocity of a magnetic disk according to the second embodiment;

FIG. 15 illustrates graphs for explaining a relationship between the amplitude level of a triple harmonic wave component and the velocity of a magnetic disk;

FIG. 16 illustrates graphs for explaining the relationship between the amplitude level of a triple harmonic wave component and the velocity of a magnetic disk;

FIG. 17 is a detailed functional block diagram of a magnetic recording apparatus according to a third embodiment of the present invention;

FIG. 18 illustrates graphs and charts for explaining the relationship between the controlled spacing and the amplitude of the detection target signal according to the third embodiment;

FIG. 19 is a drawing for explaining the mechanism that allows the read amplitude to keep having an increasing tendency;

FIG. 20 is a detailed functional block diagram of a magnetic recording apparatus according to a fourth embodiment of the present invention;

FIG. 21 illustrates graphs and charts for explaining the proportion of the change in the amplitude of the detection target signal;

FIG. 22 is a detailed functional block diagram of a magnetic recording apparatus according to a fifth embodiment of the present invention;

FIG. 23 illustrates graphs and charts for explaining the relationship between the controlled spacing and the calculated spacing according to the fifth embodiment;

FIG. 24 is a detailed functional block diagram of a magnetic recording apparatus according to a sixth embodiment of the present invention;

FIG. 25 illustrates a graphs and a chart for explaining the relationship between the controlled spacing and the calculated spacing according to the sixth embodiment;

FIG. 26 is a detailed functional block diagram of a magnetic recording apparatus according to a seventh embodiment of the present invention;

FIG. 27 illustrates a graph and a chart for explaining the relationship between the controlled spacing and the amplitude of the detection target signal according to the seventh embodiment; and

FIG. 28 is a graph for explaining the relationship between the rotation speed and the spacing according to the Japanese Examined Patent Application Publication No. 7-1618.

### DETAILED DESCRIPTION OF THE PREFERRED EMBODIMENTS

Exemplary embodiments of the present invention will be explained in detail below, with reference to the accompanying drawings.

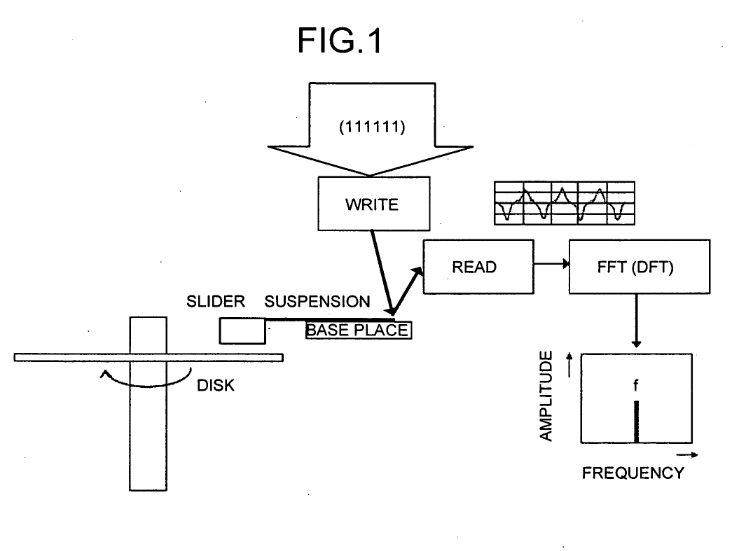

First, the technical features of a magnetic recording apparatus according to the first embodiment of the invention will be explained with reference to FIG. 1. As shown in the drawing, the magnetic recording apparatus writes, in advance, a predetermined signal pattern (for example, 111111) onto a magnetic recording medium (i.e. a magnetic disk) at a predetermined frequency (for example, 100 MHz). In the following description, the signal pattern (a signal including a predetermined frequency component) written onto the magnetic disk at the predetermined frequency will be referred to as “detection target signal”.

To detect contact of the head with the magnetic disk, the magnetic recording apparatus reads the amplitude of the predetermined frequency component in the detection target signal recorded on the magnetic disk while lowering the rotation speed of the magnetic disk (or the relative velocity between the head and magnetic disk) by a predetermined proportion. When the read amplitude of the component decreases by an amount larger than a threshold value, it is determined that the head has made contact with the magnetic disk, and thus the contact of the head is detected.

As explained above, the magnetic recording apparatus reads the amplitude of the frequency component in the signal read from the magnetic disk, judges that the head has made contact with the magnetic disk when the amplitude of the component decreases by an amount larger than the threshold value, and thus detects the contact of the head with the magnetic disk. Thus, it is possible to make the accurate judgment of whether the head is in or out of contact with the magnetic disk.

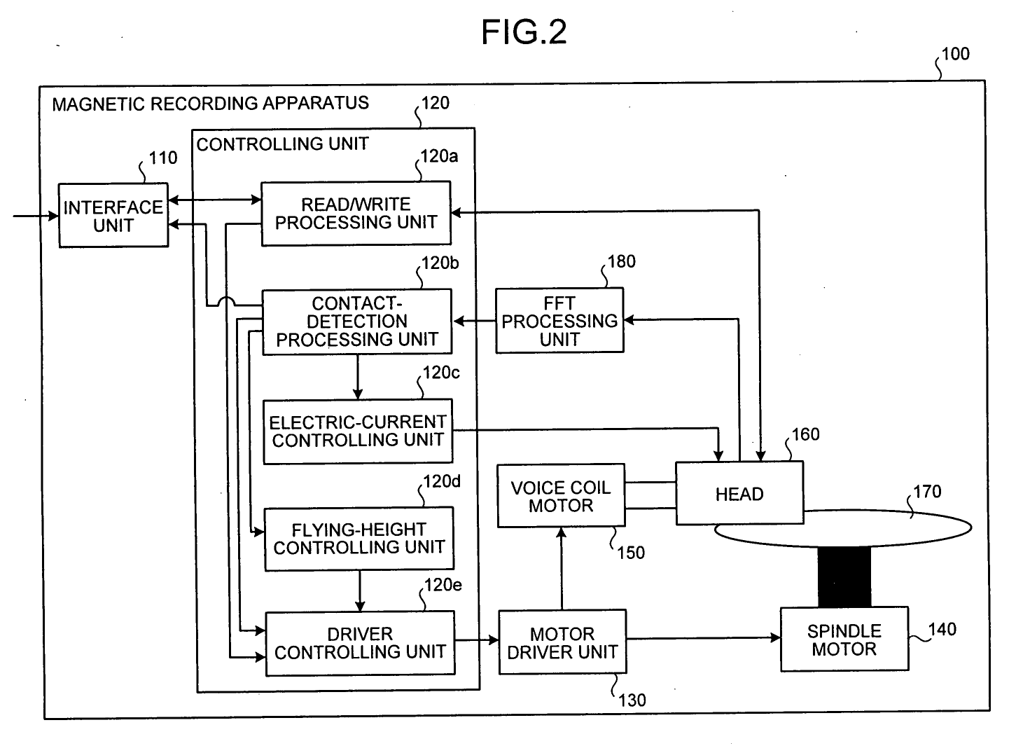

Next, the configuration of the magnetic recording apparatus 100 according to a first embodiment will be explained with reference to FIG. 2. The magnetic recording apparatus 100 includes an interface unit 110, a controlling unit 120, a motor driver unit 130, a spindle motor 140, a voice coil motor 150, a head 160, a magnetic disk 170, and a Fast Fourier Transform (FFT) processing unit 180.

The interface unit 110 is connected to a host computer (not shown), and performs data communication with the host computer using a predetermined communication protocol.

The motor driver unit 130 controls the spindle motor 140 and the voice coil motor 150 based on an instruction output by the controlling unit 120. The spindle motor 140 makes the magnetic disk 170 rotate at a predetermined rotation speed based on an instruction output by the motor driver unit 130. The voice coil motor 150 moves the head 160 attached to an end of an arm, according to an instruction output by the motor driver unit 130.

The magnetic disk 170 is a recording medium and is a flat disk made of glass or metal coated with magnetic material. To record information onto the magnetic disk 170, a magnetic field from the head 160 is irradiated onto a recording area of the magnetic disk 170 into which the information is to be recorded, so that the magnetism of the magnetic material coated on the magnetic disk 170 changes. To read information from the magnetic disk 170, the head 160 is moved to a recording area of the magnetic disk 170 from which the information is to be read, so that the magnetism of the magnetic material coated on the magnetic disk 170 is read, and the information is played back.

The FFT processing unit 180 obtains a signal read by the head 160 from the magnetic disk 170, and performs a calculation based on the Fourier Transform Theory so as to calculate an average amplitude level of the frequency component in a section used in the calculation. The FFT processing unit 180 outputs the calculated average amplitude level of the frequency component to the controlling unit 120.

Because the detection target signal is written on the magnetic disk 170 in advance (the detection target signal is written in advance by a read/write processing unit 120a), the FFT processing unit 180 outputs the average amplitude level of the frequency component in the detection target signal (hereinafter, “the amplitude level information”) to the controlling unit 120.

The controlling unit 120 controls the writing and the reading of data to and from the magnetic disk 170, and also detects contact of the head 160 with the magnetic disk 170. The controlling unit 120 includes the read/write processing unit 120a, a contact-detection processing unit 120b, an electric-current controlling unit 120c, a flying-height controlling unit 120d, and a driver controlling unit 120e.

The read/write processing unit 120a performs the writing and the reading of data to and from the magnetic disk 170 according to a write request or a read request from the host computer. The read/write processing unit 120a also writes the signal pattern (111111) onto the magnetic disk 170 at a predetermined frequency (or at various frequencies) according to an instruction from the host computer.

The contact-detection processing unit 120b detects contact of the head 160 with the magnetic disk 170. More specifically, to detect contact of the head 160 with the magnetic disk 170, the contact-detection processing unit 120b lowers the rotation speed of the magnetic disk 170 by a predetermined proportion and also obtains the amplitude level information from the FFT processing unit 180. When the amplitude of the predetermined frequency component (a first-order frequency component) decreases by an amount larger than a threshold value, the contact-detection processing unit 120b judges that the head 160 has made contact with the magnetic disk 170, and thus detects the contact of the head 160.

To lower the rotation speed of the magnetic disk 170 by the predetermined proportion, the contact-detection processing unit 120b instructs the driver controlling unit 120e to lower the rotation speed of the magnetic disk 170 by the predetermined proportion. The driver controlling unit 120e outputs an instruction to the motor driver unit 130 to control the spindle motor 140 and the voice coil motor 150. Upon receiving the instruction from the contact-detection processing unit 120b to lower the rotation speed of the magnetic disk 170 by the predetermined proportion, the driver controlling unit 120e controls the spindle motor 140 so that the number of rotations of the magnetic disk 170 decreases by the predetermined proportion.

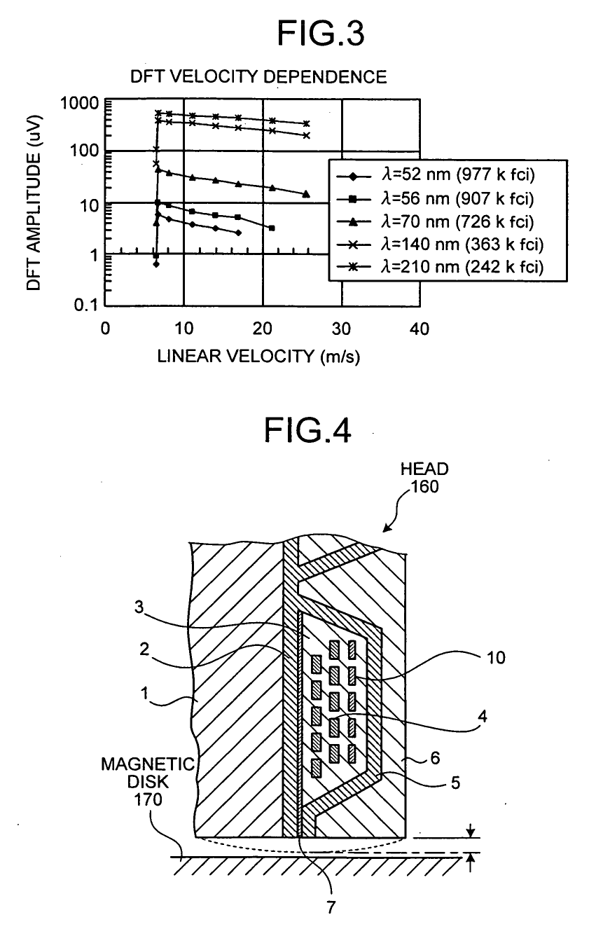

Next, the relationship between the velocity (i.e. a value obtained by converting the rotation speed to a velocity) of the magnetic disk 170 and the amplitude of the first-order frequency component (i.e. the frequency component in the detection target signal) will be explained with reference to a graph in FIG. 3. The example in FIG. 3 illustrates the relationship between the first-order frequency component and the velocity of the magnetic disk 170 observed in various detection target signals. The graph explains the relationship between the amplitude of the frequency component and the velocity of the magnetic disk for each of the different wavelengths.

It is clear from FIG. 3 that, when the velocity of the magnetic disk 170 reaches a certain level (approximately 6 m/s in the example in FIG. 3), each of the amplitudes of the first-order frequency components drastically decreases. This type of drastic decrease is observed regardless of the length of the data sequence used in the calculation in a process of the Fourier calculation processing. Also, as a result of an experiment in which a laser vibrometer (not shown) was used together, it was confirmed that the head 160 vibrated before and after the point in time when each of the amplitudes of the first-order frequency components drastically decreased.

More specifically, before each drastic decrease of the amplitudes of the first-order frequency components, head vibration did not occur; however, the moment when each of the amplitudes of the first-order frequency components drastically decreased, a head vibration occurred and this vibration lasted for a period of time. This vibration was caused by the contact of the head 160 with the magnetic disk 170.

When the rotation speed of the magnetic disk 170 increases while the head 160 is still vibrating, the amplitude of the first-order frequency component goes back to the value before the drastic decrease, and the vibration of the head 160 stops.

Returning to the description of the operation of the contact-detection processing unit 120b, after detecting the contact of the head 160 with the magnetic disk 170, the contact-detection processing unit 120b notifies the electric-current controlling unit 120c notifying that the head 160 has made contact with the magnetic disk 170.

Alternatively, after detecting the contact of the head 160 with the magnetic disk 170, the contact-detection processing unit 120b may cause a speaker (not shown) to make a warning sound to notify a manager of the magnetic recording apparatus 100 that the head 160 has made contact, or may cause the host computer to display that the head 160 has made contact.

Using electric current, the electric-current controlling unit 120c adjusts the spacing between the head 160 and the magnetic disk 170 by causing a magnetic pole tip of the head 160 to generate heat and expand. Upon receiving notification from the contact-detection processing unit 120b that the head 160 has made contact, the electric-current controlling unit 120c stops the electric current supply to the magnetic pole tip of the head 160 to cause the magnetic pole tip of the head 160 to contract. By this operation of the electric-current controlling unit 120c to cause the magnetic pole tip of the head 160 to contract, it is possible to efficiently reduce the head vibration due to the contact of the head 160.

FIG. 4 is a drawing of an example of the head 160. The head 160 includes a substrate 1 and a lower magnetic pole 2, a thin film coil 4 formed with an intervening electrically insulative layer 3, an upper magnetic pole 5, and a protective layer 6 that are sequentially formed on the substrate 1. When a thin film resistor 10 inside the electrically insulative layer 3 is caused to generate heat by electric current, due to the differences in the thermal expansion ratios between the two magnetic pole tips 2 and 5 and the electrically insulative layer 3, and between the substrate 1 and the protective layer 6, a magnetic pole tip 7 projects outward as shown with a dotted line in FIG. 4. In other words, by having the electric-current controlling unit 120c control the electric current flowing in the thin film resistor 10, it is possible to control the amount of projection of the magnetic pole tip 7.

Returning to the description of the operation of the contact-detection processing unit 120b, the contact-detection processing unit 120b calculates a flying height of the head 160 based on, for example, the amplitude level information received from the FFT processing unit 180.

The flying height of the head 160 can be calculated using the Wallace relationship equation shown below:

$${( d + a )}_{x} - {( d + a )}_{ref} = \frac{λ}{2 π} ln ( \frac{{V}_{ref}}{{V}_{x}} ) \qquad ( 1 )$$

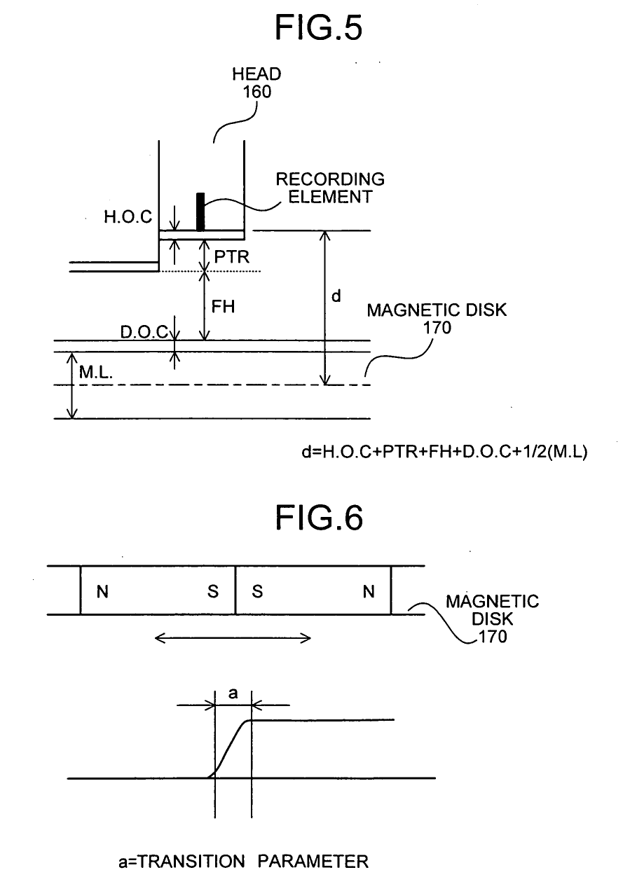

Next, the symbols “a” and “d” used in Equation (1) will be explained. FIG. 5 and FIG. 6 are drawings for explaining the Wallace relationship equation.

As shown in FIG. 5, the symbol “d” used in Equation (1) denotes a sum of the Head Over Coat (H. O. C.), the Pole Tip Recession (P. T. R.), the Flying Height (F. H.), the Disk Over Coat (D. O. C.), and a half of the Magnetic Layer (M. L.). As shown in FIG. 6, the symbol “a” used in Equation (1) denotes a transition parameter, which is the width of a transition area in which the signal strength on the magnetic disk varies.

A reference value (for example, a value at a point in time when the head 160 makes contact with the magnetic disk 170) is assigned to a character having a subscript “ref” (reference). The contact-detection processing unit 120b obtains reference values in advance, and uses the reference values for the calculation of the flying height. A reference value of the amplitude level is assigned to V_{ref} used in Equation (1). A value of the amplitude level at the velocity for which the flying height is to be calculated is assigned to Vₓ.

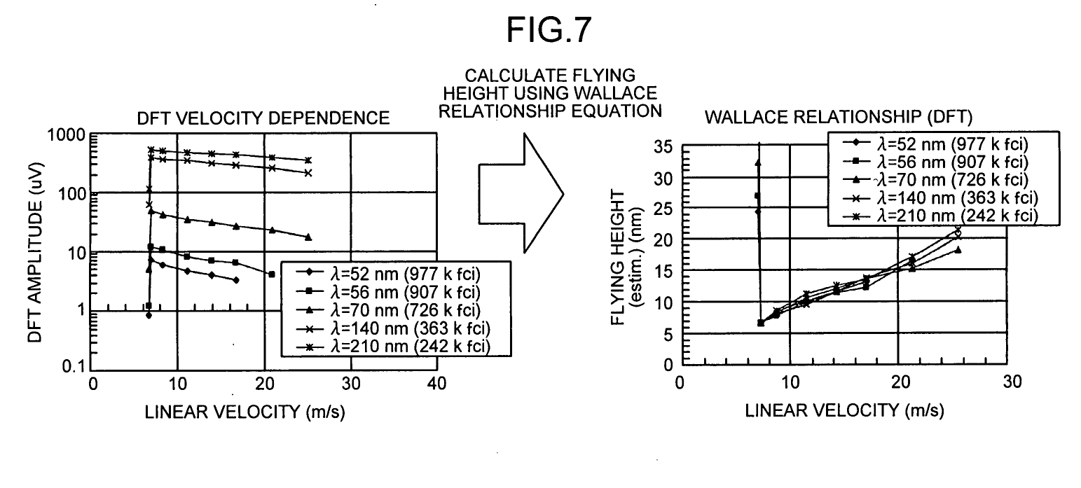

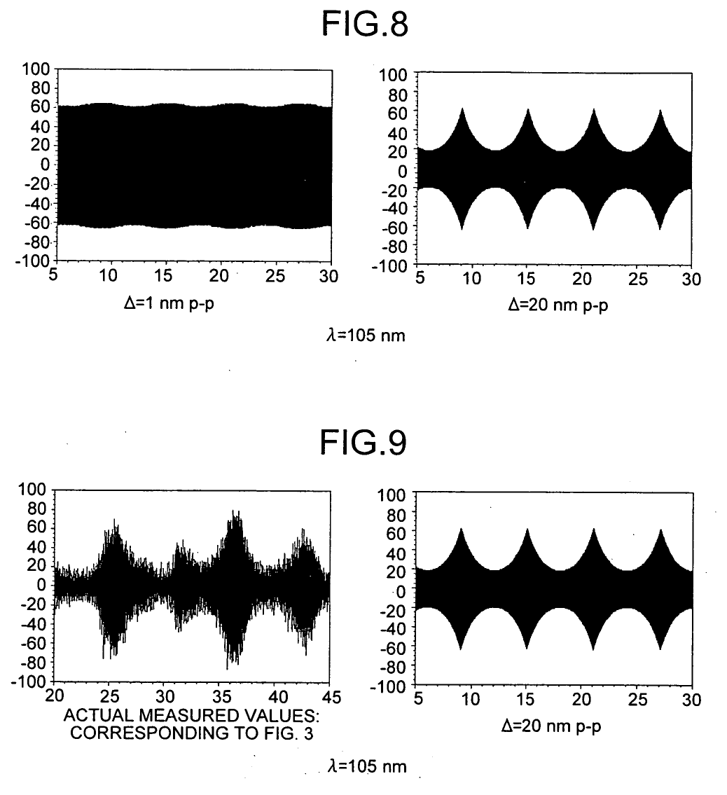

FIG. 7 illustrates graphs for explaining the relationship between the flying height of the head 160 and the velocity of the magnetic disk 170. The graph on the left side in FIG. 7 is for explaining the relationship between the amplitude of the first-order frequency component and the velocity of the magnetic disk 170, as explained using FIG. 3. By applying the Wallace relationship equation to the relationship shown in the graph on the left, the relationship between the flying height of the head 160 and the velocity of the magnetic disk 170 can be calculated, as shown in the graph on the right side in FIG. 7. As shown in the graph on the right, when the velocity of the magnetic disk 170 has reached a certain level, the flying height of the head 160 increases by a large amount. It is understood that the head 160 made contact with the magnetic disk 170 at this point in time.

The contact-detection processing unit 120b provides the flying-height controlling unit 120d with information regarding the relationship between the flying height of the head 160 and the velocity of the magnetic disk 170 (hereinafter “the flying height control information”), the relationship being calculated using the Wallace relationship equation.

The flying-height controlling unit 120d receives the flying height control information from the contact-detection processing unit 120b and controls the driver controlling unit 120e so that the head 160 does not make contact with the magnetic disk 170. More specifically, as shown in the example in FIG. 7, when the velocity of the magnetic disk 170 is equal to or lower than a predetermined level (approximately 6 m/s in the example in FIG. 7), the head 160 makes contact with the magnetic disk 170. Thus, the flying-height controlling unit 120d controls the driver controlling unit 120e so that the velocity of the magnetic disk 170 does not become equal to or lower than the predetermined level.

Because it is preferable to make the spacing between the head 160 and the magnetic disk 170 as small as possible, the flying-height controlling unit 120d controls the driver controlling unit 120e so that the spacing between the head 160 and the magnetic disk 170 is kept the same as the spacing at a time immediately before the head 160 makes contact with the magnetic disk 170 (hereinafter, “the optimal spacing”); in other words, so that the flying height of the head 160 is equal to the optimal spacing (or a value obtained by multiplying the optimal spacing by a predetermined value).

Further, the amplitude of a read signal that corresponds to the spacing between the head 160 and the magnetic disk 170 can be calculated using the Wallace relationship equation. FIG. 8 illustrates graphs for explaining the amplitude of a read signal that corresponds to the spacing between the head 160 and the magnetic disk 170. The example shown in FIG. 8 presents results of trial calculations of the amplitude of a read signal on a presumption that a write signal is at approximately 100 MHz (k=105 nm), the air bearing modulation frequency is approximately 170 kHz (kilohertz), and the amount of change in the spacing (i.e. the spacing between the head 160 and the magnetic disk 170) due to the air bearing is one of two possibilities, namely 1 nm (when there is no occurrence of contact vibration of the head 160) and 20 nm (when there is occurrence of contact vibration of the head 160).

FIG. 9 illustrates graphs of the results of the trial calculations in which the amount of change in the spacing due to the air bearing is presumed to be 20 nm, and the actual measured values of the read signal waveforms at the time of contact vibration occurrence. In FIG. 9, the waveforms on the left are the actual measured values of the read signal waveforms, whereas the waveforms on the right are the results of the trial calculations of the read signal waveforms. As we compare the waveforms on the left with the ones on the right, it is observed that these waveforms are very similar to each other. Thus, it is concluded that the read signal level at the time of the vibration continuation, shown in FIG. 3, has decreased due to the contact between the head 160 and the magnetic disk 170.

More specifically, according to the results shown in FIG. 3, vibration occurs because of the contact between the head 160 and the magnetic disk 170 when the velocity becomes lower than a certain level. Because of this vibration, it looks as if the amplitude of the first-order frequency component decreased drastically due to the appearance after averaging the values during the period. (In the example shown in FIG. 7, it looks as if the spacing between the head 160 and the magnetic disk 170 increased). Note that the vibration amplitude at this time is approximately tens of nanometers p-p (peak to peak) to 0.1 μm p-p.

The reason why there is vibration as soon as the head 160 makes contact with the magnetic disk 170 is that the degree of unevenness of the magnetic disk 170 is rather small, and that the magnetic disk 170 is a smooth-surfaced medium having an average unevenness smaller than the thickness of the lubricant film formed on the surface of the magnetic disk 170. The average unevenness of the magnetic disk 170 is within the range of approximately 0.3 nm to 0.5 nm. The thickness of the lubricant film formed on the surface of the medium through a lubrication processing is within the range of approximately 0.8 nm to 2.8 nm.

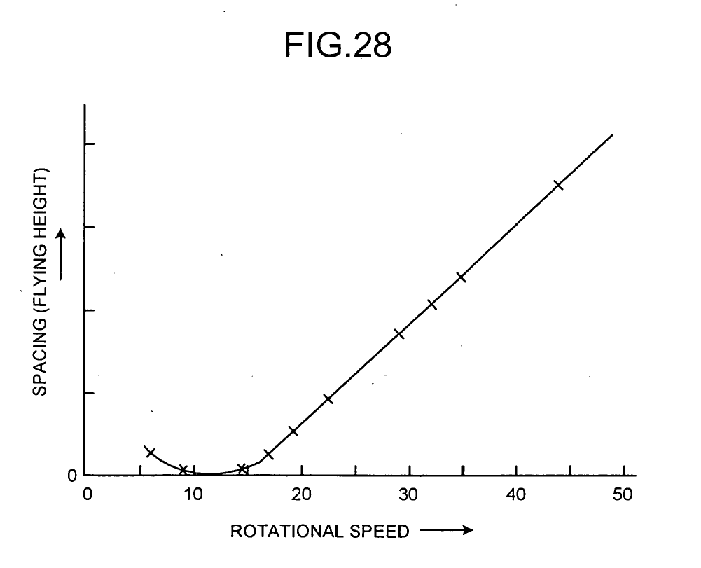

The relationship between the read signal and the velocity of the disk (shown in FIG. 28) discussed in the Japanese Examined Patent Application Publication No. 7-1618 is observed only when the average unevenness of a magnetic disk is extremely larger than that of the magnetic disk 170 according to the first embodiment. In recent years, the average unevenness of most of magnetic disks being used is at the same level as the unevenness of the magnetic disk according to the first embodiment. Thus, the head contact detection method according to the first embodiment is more effective than the method disclosed in the Japanese Examined Patent Application Publication No. 7-1618.

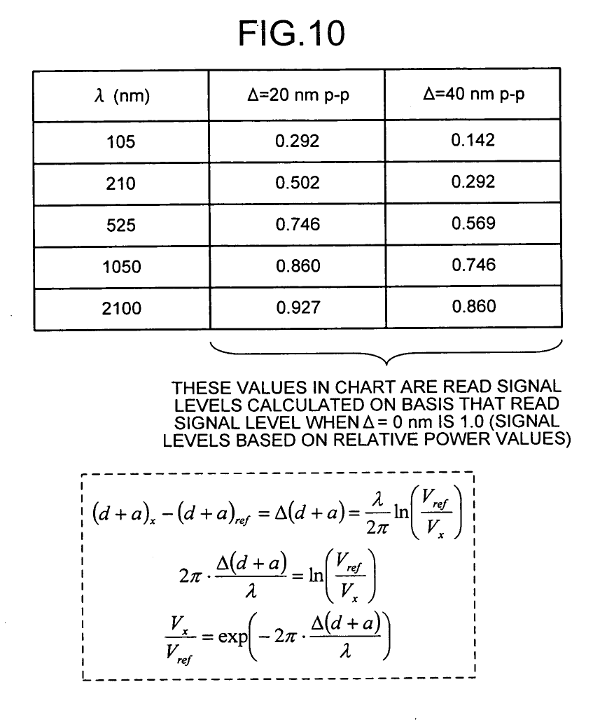

Calculations that are the same as the ones shown in FIG. 8 were performed using various write frequencies and various amounts of changes in the spacing (20 nm p-p and 40 nm p-p). FIG. 10 is a table for showing the results of the calculations for the amplitude of the read signal with the various write frequencies and the various amounts of changes in the spacing. In FIG. 10, the write frequencies are converted to write signals of wavelengths λ (on the medium).

As shown in FIG. 10, the read signal level at the time of the vibration continuation is determined substantially according to the value of the amount of the change/λ. In other words, it is possible to conclude the amplitude value of vibration by monitoring the read signal level after occurrence of the vibration.

Further, the amplitude of a read signal can be expressed using a simple exponential function based on the Wallace relationship equation, as shown by the equations in FIG. 10. It is possible to estimate the amplitude of vibration using the write wavelength λ that is known from the conditions used in the experiment and V_{ref} and Vₓ that are clearly indicated in the actual measured values. The amplitude of vibration may be estimated by, for example, the contact-detection processing unit 120b shown in FIG. 2. In such a situation, the contact-detection processing unit 120b outputs the calculated amplitude of vibration to the host computer to provide the manager with the amplitude of vibration.

As explained so far, in the magnetic recording apparatus 100 according to the first embodiment, the read/write processing unit 120a writes onto the magnetic disk 170, in advance, a signal that includes the predetermined frequency component, the contact-detection processing unit 120b controls the driver controlling unit 120e so that the rotation speed of the magnetic disk 170 is lowered by a predetermined portion, to thereby read the detection target signal. When the amplitude of the predetermined frequency component (the first-order frequency component) in the signal read from the magnetic disk 170 decreases by an amount larger than the threshold value, it is judged that the head 160 has made contact with the magnetic disk 170, and thus the contact of the head 160 is detected. Accordingly, it is possible to detect the contact of the head 160 with the magnetic disk 170 accurately, while avoiding technical ambiguity of the conventional technique.

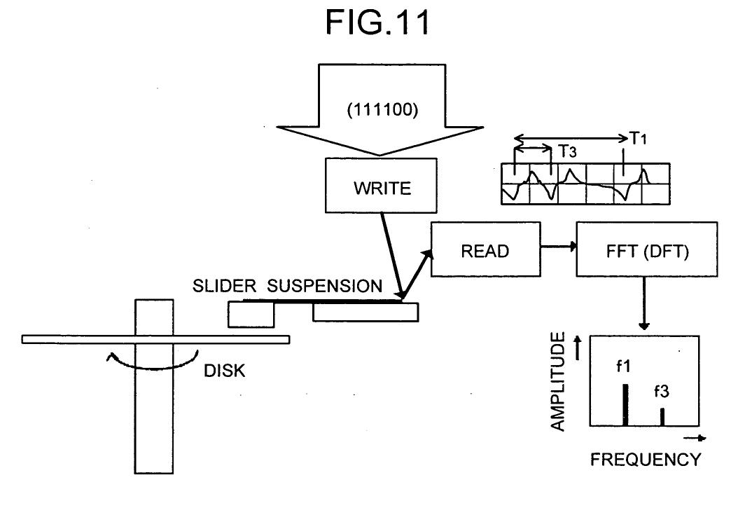

Next, technical features of a magnetic recording apparatus according to a second embodiment of the present invention will be explained with reference to FIG. 11. As shown in the drawing, the magnetic recording apparatus writes onto a magnetic disk, in advance, a signal pattern (e.g. 111100) that includes two waves, namely a first-order component and a triple harmonic wave component, at a predetermined frequency. In the following description, a signal that includes a plurality of frequency components will be referred to as a complex signal.

To detect contact of a head with a magnetic disk, the magnetic recording apparatus reads the amplitudes of predetermined frequency components (for example, the first-order component and the triple harmonic wave component) in the complex signal recorded on the magnetic disk while lowering the rotation speed of the magnetic disk by a predetermined proportion. Contact of the head is detected based on the amplitudes of the two types of frequency components that have been read. Defects in the magnetic disk are also detected based on the magnitudes of the amplitudes of these frequency components.

The magnetic recording apparatus according to the second embodiment detects contact of the head based on changes in the amplitudes of the frequency components. Thus, it is possible to make accurate judgment of whether the head is in or out of contact with a medium. Further, it is possible to accurately detect defects in a magnetic disk, based on the amplitude of one of the first-order component and the triple harmonic wave component in the complex signal.

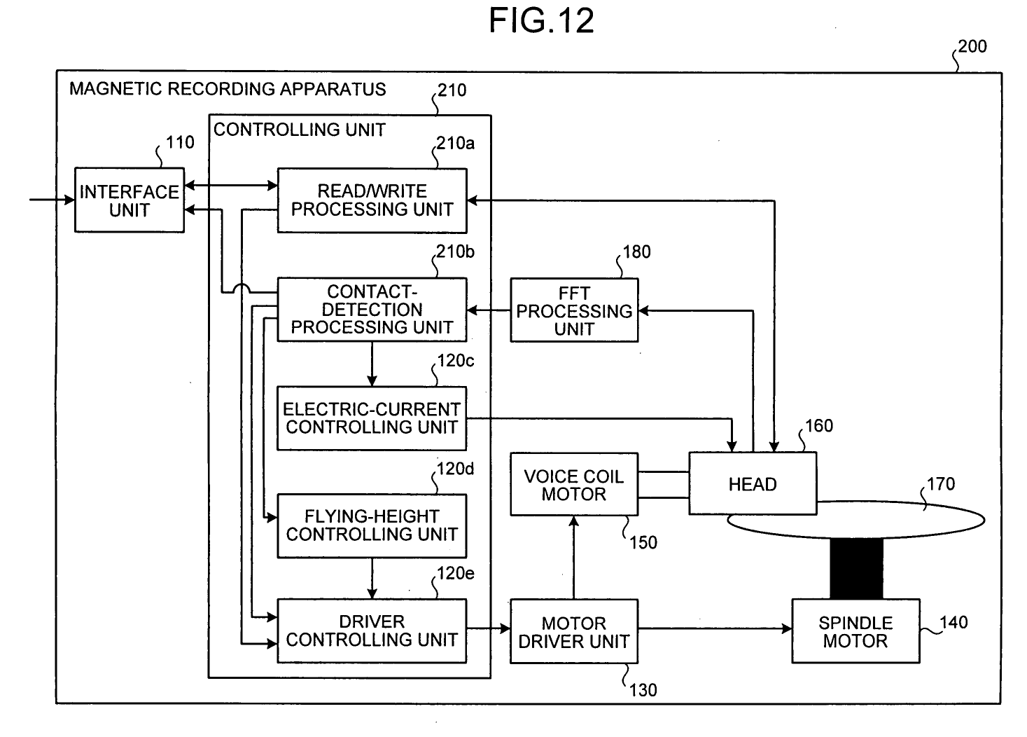

Next, a configuration of a magnetic recording apparatus 200 according to the second embodiment will be explained with reference to FIG. 12. The magnetic recording apparatus 200 includes a controlling unit 210. Other configurations and constituent elements of the magnetic recording apparatus 200 are same as those of the magnetic recording apparatus 100 shown in FIG. 2. The same reference numerals are used for identical constituent elements, and explanation thereof will be omitted.

The controlling unit 210 controls the writing and the reading of data to and from the magnetic disk 170 and also detects contact of the head 160 with the magnetic disk 170 and defects in the magnetic disk 170. The controlling unit 210 includes a read/write processing unit 210a and a contact-detection processing unit 210b. Other configurations of the controlling unit 210 are the same as those of the controlling unit 120 shown in FIG. 2. The same reference numerals are used for referring to identical constituent elements, and explanation thereof will be omitted.

The read/write processing unit 210a performs the writing and the reading of data to and from the magnetic disk 170 based on a write request or a read request from a host computer. The read/write processing unit 210a also writes the signal pattern (111100) onto the magnetic disk 170 at a predetermined frequency (or at various frequencies) based on an instruction from the host computer.

The contact-detection processing unit 210b detects contact of the head 160 with the magnetic disk 170 and defects in the magnetic disk 170. The operation performed by the contact-detection processing unit 210b to detect contact of the head 160 with the magnetic disk 170 will be explained first.

To detect contact of the head 160 with the magnetic disk 170, the contact-detection processing unit 210b lowers the rotation speed of the magnetic disk 170 by a predetermined proportion and also obtains the amplitude level information of the first-order component and the triple harmonic wave component from the FFT processing unit 180. When a value calculated from the relationship between the amplitude levels of the frequency components (hereinafter, “the complex amplitude value”) decreases by an amount larger than a threshold value, the contact-detection processing unit 210b judges that the head 160 has made contact with the magnetic disk 170 and thus detects the contact of the head 160.

The complex amplitude value A is calculated using Equation (2) shown below:

$$A = \frac{3 λ}{4 π} ln \frac{{V}_{1}}{{V}_{3}} \qquad ( 2 )$$

In Equation (2), the symbol V₁ denotes the amplitude level of the first-order frequency component. The symbol V₃ denotes the amplitude level of the triple harmonic wave component.

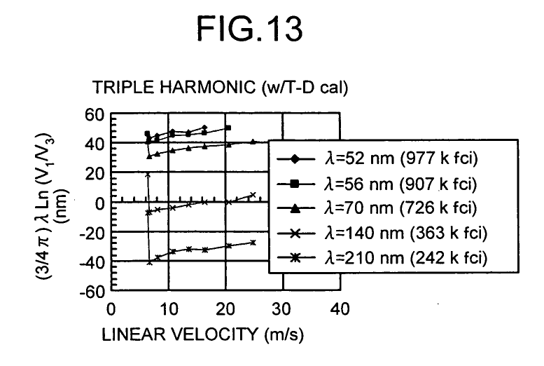

FIG. 13 is a graph for explaining the relationship between the velocity of the magnetic disk 170 and the complex amplitude value. It can be observed from the drawing that, when the velocity of the magnetic disk 170 reaches a certain level (approximately 6 m/s) in the example in FIG. 13), the complex amplitude value drastically increases.

Also, as a result of an additional experiment in which a laser vibrometer (not shown) was used together, it was observed that the head 160 vibrated before and after the drastic increase. More specifically, before each drastic increase of the complex amplitude values, head vibration did not occur; however, the moment when each of the complex amplitude values drastically increased, head vibration occurred and this vibration lasted for a period of time. This vibration was caused by the contact of the head 160 with the magnetic disk 170. When the rotation speed of the magnetic disk 170 increases while the head 160 is still vibrating, the vibration of the head 160 stops.

Returning to the description of the operation of the contact-detection processing unit 210b, upon receiving the amplitude level of the first-order component and the triple harmonic wave component from the FFT processing unit 180, the contact-detection processing unit 210b calculates the flying height of the head 160 based on the received amplitude level, using the Equation (3) shown below:

$$( d + a ) = \frac{3 λ}{4 π} ln ( \frac{{V}_{1}}{{V}_{3}} ) + const . ( λ , g ) \qquad ( 3 )$$

The symbols “d” and “a” used in Equation (3) are the same as the symbols “d” and “a” used in Equation (1). Explanation thereof will be therefore omitted. In Equation (3), the symbol V₁ denotes the amplitude level of the first-order frequency component. The symbol V₃ denotes the amplitude level of the triple harmonic wave component.

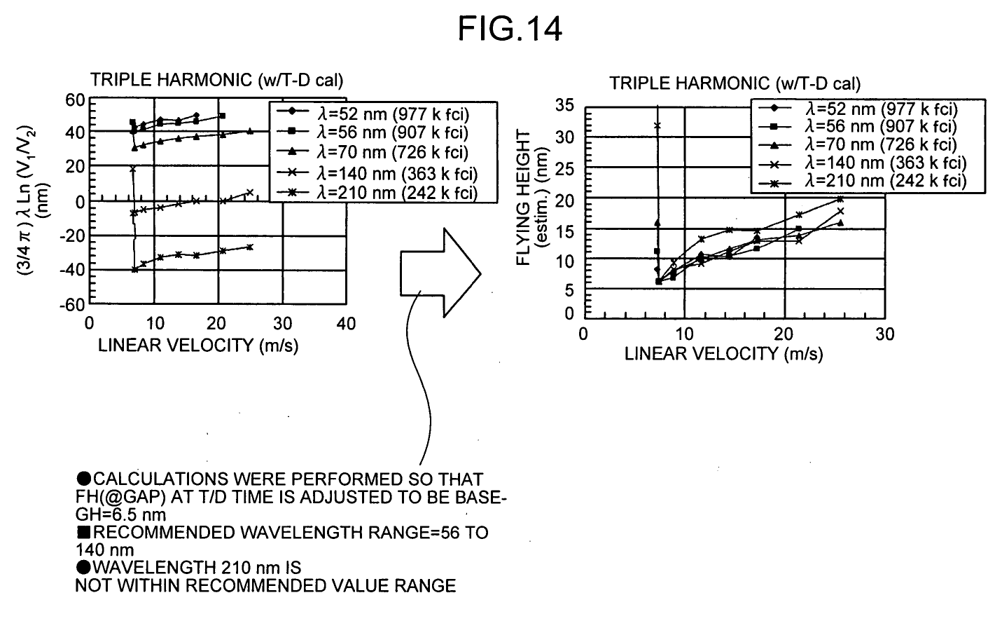

FIG. 14 illustrates graphs for explaining the relationship between the flying height of the head 160 and the velocity of the magnetic disk 170. The graph on the left side in FIG. 14 is for explaining the relationship between the complex amplitude value and the velocity of the magnetic disk 170, as explained using FIG. 13. By applying Equation (3), the relationship between the flying height of the head 160 and the velocity of the magnetic disk 170 can be calculated, as shown in the graphs on the right side in FIG. 14.

Because Equation (3) includes unspecified constants, namely “Const. (λ, g)”, calculations were performed to adjust the value of the minimum flying height of the head 160 (i.e. the flying height at the time immediately before the head 160 makes contact with the magnetic disk 170 in the example shown in FIG. 14) to be 6.5 nm. The minimum flying height 6.5 nm is obtained as a result of a measuring process using a generally-used method for detecting contact (For example, the method for detecting contact that is disclosed in Japanese Patent Application Laid-open No. H9-63050 may be used.). (The contact-detection processing unit 210b has detected the minimum flying height in advance). To be more specific, the contact-detection processing unit 210b calculates the relationship between the flying height and the velocity of the magnetic disk 170, using the minimum flying height that is measured using the generally-used method for detecting contact (i.e. 6.5 nm according to the second embodiment) and Equation (3).

As shown in FIG. 14, when the velocity of the magnetic disk 170 has reached a predetermined level, the flying height of the head 160 increases by a large amount. It is understood that the head 160 has made a contact with the magnetic disk 170 at this time.

The contact-detection processing unit 210b sends to the flying-height controlling unit 120d, the relationship between the flying height of the head 160 and the velocity of the magnetic disk 170, the relationship being calculated using Equation (3). Also, when the head 160 has made contact with the magnetic disk 170, the contact-detection processing unit 210b notifies the electric-current controlling unit 120c that the head 160 has made contact with the magnetic disk 170.

Next, the operation performed by the contact-detection processing unit 210b to detect defects in the magnetic disk 170 will be explained. To detect defects in the magnetic disk 170, the contact-detection processing unit 210b monitors the amplitude level of the triple harmonic wave component. When the value of the amplitude level of the triple harmonic wave component becomes lower than a predetermined value, the contact-detection processing unit 210b judges that the head 160 has made contact with a defect in the magnetic disk 170. The predetermined value is one of a noise level of the magnetic disk 170, a noise level of the magnetic recording apparatus 200, and a value obtained by multiplying one of these noise levels by a predetermined value (for example, a value within the range of 1.0 to 1.3).

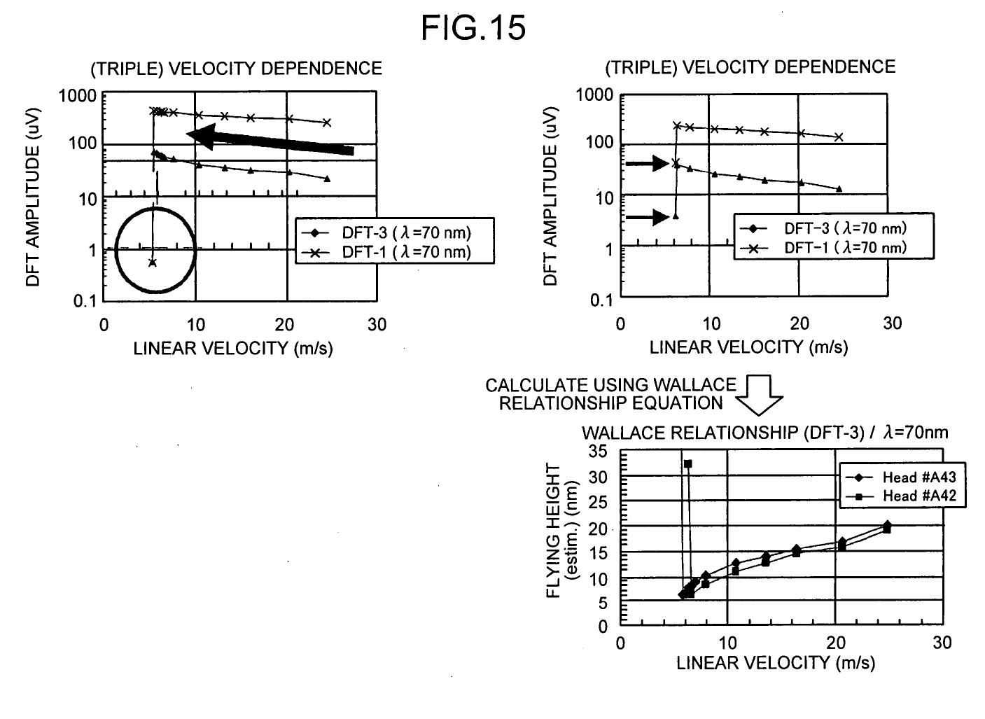

FIG. 15 illustrates graphs for explaining the relationship between the amplitude level of the triple harmonic wave component and the velocity of the magnetic disk 170. As shown in the graph on the left side in FIG. 15, when the head 160 has made contact with a defect in the magnetic disk 170, each of the values of the amplitude levels is substantially at the same level as the noise level of the magnetic recording apparatus 200. On the other hand, when the head 160 has made contact with the magnetic disk 170, each of the values of the amplitude levels of the frequency components is more than 10 times larger than the noise level, as shown in the graph on the right side in FIG. 15.

Generally speaking, when the magnetic disk 170 has a defect (e.g. a flaw or dust), the height of such a flaw (for example, a flaw that is large enough to be visible and caused by contact of the head 160 with the magnetic disk 170) may be 0.2 micrometer to a few micrometers. When the head 160 has moved to a position with such a flaw, the spacing between the head 160 and the magnetic disk 170 becomes larger than the vibration due to the contact of the head 160 with the magnetic disk 170, and thus the amplitude level of the triple harmonic wave component (or the first-order frequency component) decreases by a large amount.

After detecting a defect in the magnetic disk 170, the contact-detection processing unit 210b may cause a speaker (not shown) to output a warning sound to notify a manager of the magnetic recording apparatus 200 that the head 160 has made contact with the defect, or may cause the host computer to display that the head 160 has made contact with the defect.

Moreover, the contact-detection processing unit 210b can detect contact of the head 160 in the same way as the contact-detection processing unit 120b does according to the first embodiment, by focusing on only one frequency component out of the first-order component and the triple harmonic wave component in a complex signal.

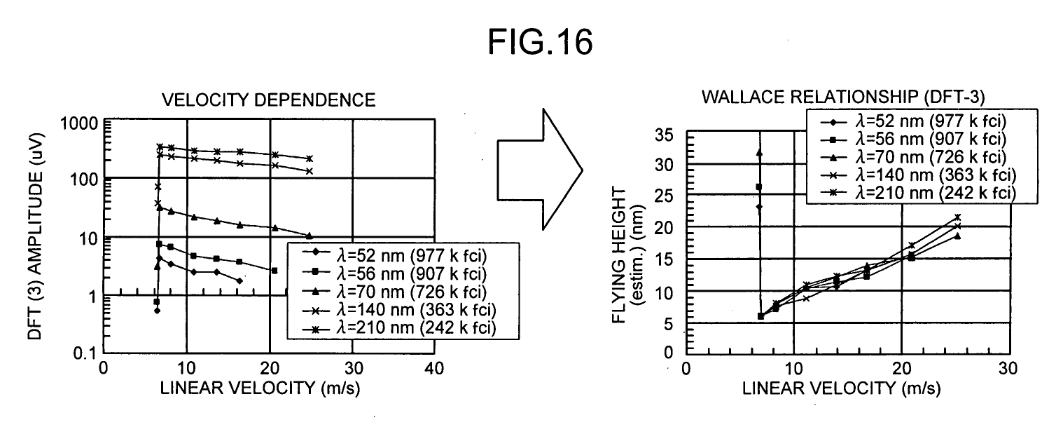

FIG. 16 illustrates graphs for explaining the relationship between the amplitude level of the triple harmonic wave component and the velocity of the magnetic disk 170. As shown in FIG. 16, it is possible to obtain results that are equivalent to the results shown in FIG. 7 by focusing only on the amplitude level of the triple harmonic wave component.

As explained so far, in the magnetic recording apparatus 200 according to the second embodiment, the read/write processing unit 210a writes onto the magnetic disk 170, in advance, the complex signal that includes the plurality of frequency components, the contact-detection processing unit 210b controls the driver controlling unit 120e so that the rotation speed of the magnetic disk 170 is lowered by a predetermined portion, to thereby read the complex signal. When the complex amplitude value of the frequency components (the first-order frequency component and the triple harmonic wave component) in the signal read from the magnetic disk 170 decreases by an amount larger than the threshold value, it Is judged that the head 160 has made contact with the magnetic disk 170, and thus the contact of the head 160 is detected. Accordingly, it is possible to accurately detect the contact of the head 160 with the magnetic disk 170.

Also, by focusing on the amplitude of the triple harmonic wave component, the contact-detection processing unit 210b judges that the head 160 has made contact with a defect in the magnetic disk 170 when the amplitude becomes lower than a predetermined value, and thus detects the defect in the magnetic disk 170. Accordingly, it is possible to accurately detect a defect (a flaw or dust) in the magnetic disk 170 while properly distinguishing contact of the head 160 with the magnetic disk 170 from contact of the head 160 with a defect in the magnetic disk 170.

According to the second embodiment, the contact-detection processing unit 210b detects contact of the head 160 and defects by focusing on the amplitude levels of the first-order component and the triple harmonic wave component in the complex signal; however, the present invention is not limited to this example. It is possible to obtain the similar results by using any signal pattern that includes two waves having mutually different wavelengths and the amplitudes of these components.

Thus, according to one aspect of the present invention, it is possible to make accurate judgment of whether the head is in or out of contact with the magnetic disk.

Moreover, defects on the head can be detected precisely.

Furthermore, it is possible to quickly stop vibrations caused when the head makes contact with the recording medium.

Next, the technical features of a magnetic recording apparatus according to a third embodiment of the present invention will be explained. The magnetic recording apparatus according to the third embodiment writes, in advance, a signal pattern including a predetermined frequency component (for example, 111111 or 111100) onto a magnetic disk at a predetermined frequency (for example, 100 MHz). In the following description, the signal pattern (the signal including the predetermined frequency component) written onto the magnetic disk at the predetermined frequency (or at the predetermined frequencies) will be referred to as “detection target signal”, like in the description of the first embodiment.

To detect contact of the head with the magnetic disk, the magnetic recording apparatus reads the amplitude of the predetermined frequency component in the detection target signal recorded on the magnetic disk while adjusting the spacing between the head and the magnetic disk (i.e. while gradually decreasing the spacing by regular increments) using electric current (i.e. heating the magnetic pole tip with a heater) and causing the magnetic pole tip of the head to thermally expand. When the amount of change in the read amplitude becomes smaller than a threshold value, it is judged that the head has made contact with the magnetic disk, and thus the contact of the head is detected.

As explained above, the magnetic recording apparatus according to the third embodiment reads the amplitude of the predetermined frequency component in the detection target signal recorded on the magnetic disk while decreasing the spacing between the head and the magnetic disk by regular increments by heating the magnetic pole tip of the head with the heater. When the amount of change in the amplitude becomes smaller than the threshold value, it is judged that the head has made contact with the magnetic disk, and thus the contact of the head with the magnetic disk is detected. Consequently, it is possible to accurately detect whether the head is in or out of contact with the magnetic disk, even if the amplitude of the component does not clearly start to show a decrease.

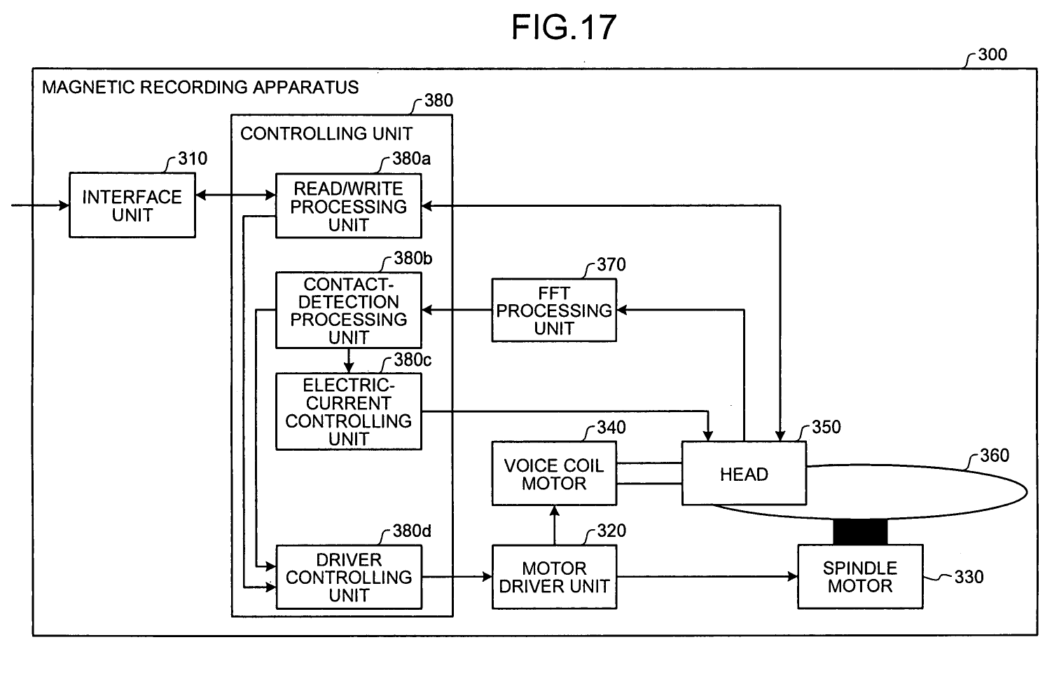

Next, a configuration of the magnetic recording apparatus according to the third embodiment will be explained. FIG. 17 is a functional block diagram of a magnetic recording apparatus 300 according to the third embodiment. The magnetic recording apparatus 300 includes an interface unit 310, a motor driver unit 320, a spindle motor 330, a voice coil motor 340, a head 350, a magnetic disk 360, an FFT processing unit 370, and a controlling unit 380.

The interface unit 310, the motor driver unit 320, the spindle motor 330, the voice coil motor 340, the head 350, the magnetic disk 360, the FFT processing unit 370 are respectively the same as the interface unit 110, the motor driver unit 130, the spindle motor 140, the voice coil motor 150, the head 160, the magnetic disk 170, and the FFT processing unit 180. Thus, the explanation of these elements will be omitted.

The controlling unit 380 controls the writing and the reading of data to and from the magnetic disk 360, and also detects contact of the head 350 with the magnetic disk 360. The controlling unit 380 includes a read/write processing unit 380a, a contact-detection processing unit 380b, an electric-current controlling unit 380c, and a driver controlling unit 380d.

The read/write processing unit 380a performs the writing and the reading of data to and from the magnetic disk 360 according to a write request or a read request from the host computer. The read/write processing unit 380a also writes the signal pattern (111111 or 111100) onto the magnetic disk 360 at a predetermined frequency (or at various frequencies) according to an instruction from the host computer.

The contact-detection processing unit 380b detects contact of the head with the magnetic disk 360. More specifically, the contact-detection processing unit 380b controls the electric-current controlling unit 380c and the driver controlling unit 380d and reads the detection target signal while changing the spacing between the head 350 and the magnetic disk 360 by the regular increments. The contact-detection processing unit 380b detects the contact of the head 350, based on the amount of change in the amplitude of the predetermined frequency component in the read detection target signal.

Using electric current, the electric-current controlling unit 380c adjusts the spacing between the head 350 and the magnetic disk 360 by causing a magnetic pole tip of the head 350 to generate heat and expand. According to the third embodiment, to allow the contact-detection processing unit 380b to detect the contact of the head, the electric-current controlling unit 380c supplies electric current to the magnetic pole tip of the head 350 so that the spacing between the head 350 and the magnetic disk 360 is decreased by a regular proportion.

Upon receiving notification from the contact-detection processing unit 380b that the head 350 has made contact, the electric-current controlling unit 380c stops the electric current supply to the head 350 to cause the magnetic pole tip of the head 350 to contract. With this arrangement, it is possible to efficiently reduce the head vibrations that are caused when the head 350 makes contact with the magnetic disk 360. The explanation of the configuration of the head 350 is the same as the explanation of the configuration of the head 160 shown in FIG. 4. Thus, the explanation of the head 350 will be omitted.

The driver controlling unit 380d outputs an instruction to the motor driver unit 320 and controls the spindle motor 330 and the voice coil motor 340.

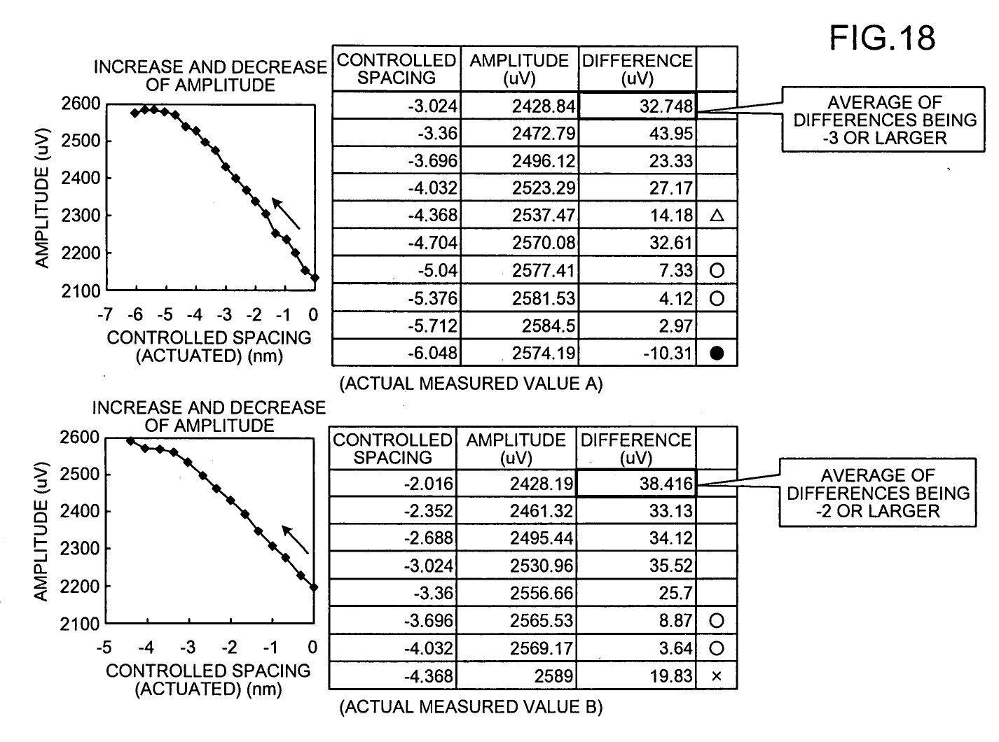

Next, the relationship between the spacing between the head 350 and the magnetic disk 360 under the control (hereinafter, “the controlled spacing”) and the amplitude (of the predetermined frequency component) in the detection target signal read from the magnetic disk 360 will be explained. FIG. 18 illustrates graphs and charts for explaining the relationship between the controlled spacing and the amplitude of the detection target signal according to the third embodiment. First, as shown in the upper section in FIG. 18 (the actual measured value A), when the controlled spacing is decreased by the regular proportion, the amplitude of the signal read from the magnetic disk 360 (i.e. the amplitude of the detection target signal) gradually changes from having an increasing tendency to having a decreasing tendency.

When the amount of change in the amplitude of the signal is no longer substantially regular, the contact-detection processing unit 380b judges that the head 350 has made contact with the magnetic disk 360. In other words, the contact-detection processing unit 380b decreases the controlled spacing by the regular proportion and calculates the average value of the amounts of change in the amplitude of the signal. The contact-detection processing unit 380b then detects the contact of the head 350 by comparing the amount of change (the difference) in the amplitude between the measuring points with a threshold value defined based on the average value.

The threshold value may be defined using any method. According to the third embodiment, however, the threshold value is defined by multiplying the average value by a predetermined value (a predetermined value between 0 and 1). In the upper section in FIG. 18, the average value of the amounts of change in the amplitude of the signal is “32.748”. When the predetermined value used for defining the threshold value is “0.5”, for example, the threshold value is defined as “16.374”. The contact-detection processing unit 380b compares the amount of change (the difference) in the amplitude between the measuring points with the threshold value “16.375”. When the amount of change (the difference) becomes smaller than the threshold value, the contact-detection processing unit 380b judges that the head 350 has made contact with the magnetic disk 360. After detecting the contact, the contact-detection processing unit 380b notifies the electric-current controlling unit 380c that the head 350 has made contact.

In the upper section in FIG. 18, the “difference” that is smaller than the threshold value is detected at the point with the controlled spacing “−4.368 nm” and also at the point with the controlled spacing “−5.04 nm” and all the points underneath. Because the point with the controlled spacing “−4.368 nm” is one point that is isolated from the other points having smaller differences, this point is considered as a noise in the measurement. Accordingly, when two or more points in a row have a difference value that is smaller than the threshold value, the contact-detection processing unit 380b judges that the head 350 has made contact with the magnetic disk 360. In the upper section in FIG. 18, the point with the controlled spacing “−5.04 nm” is considered as the contact starting point.

According to Japanese Examined Patent Application Publication No. H7-1618, when there is no longer an increasing tendency, it is considered that the head has made contact. When this idea is applied to the present example, it is considered that the contact starts at the point with the controlled spacing “−6.048 nm”. Based on the idea used in the contact detection process according to the embodiment disclosed Japanese Examined Patent Application Publication No. H7-1618, the contact starting point is different from the one based on the idea used in the contact detection process according to the present invention.

On the other hand, if the idea of when there is no longer an increasing tendency, it is considered that the head has made contact, which is used in the embodiment disclosed in Japanese Examined Patent Application Publication No. H7-1618, is applied to the example shown in the lower section in FIG. 18 (i.e. the actual measured value B), there is no such point at which there is no longer an increasing tendency. Thus, it is not possible to detect the contact of the head. If the idea according to the third embodiment of the present invention is applied, however, it is possible to find a difference that is smaller than the threshold value (which is obtained by multiplying the average value “38.416” by 0.5″). Thus, it is possible to detect the contact starting point, which is the point with the controlled spacing “−3.696”.

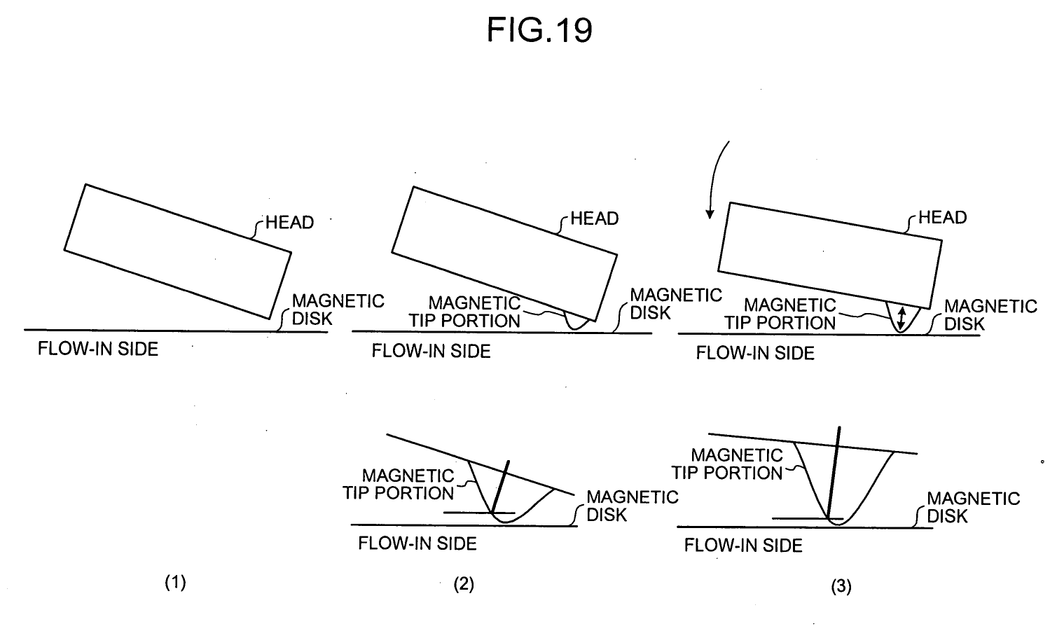

When a large number of actual measurement values have been collected, we find that there are a certain number of situations where the read amplitude keeps having an increasing tendency even after the head has made contact and does not change, for a long period of time, from having the increasing tendency to having a decreasing tendency, like the example shown as the actual measured value B. The following is an observation about this phenomenon that attempts to present an example of a possible mechanism, which is explained with reference to FIG. 19.

FIG. 19 is a schematic for explaining the mechanism that allows the read amplitude to keep having an increasing tendency. Applied to this example is the electric-current controlling unit that adjusts the spacing between the head and the magnetic disk by making the magnetic pole tip of the head thermally expand, using electric current (i.e. by heating the magnetic pole tip with a heater). Thus, the flying height is controlled (i.e. the spacing is controlled) in such a manner that the magnetic pole tip of the head swells to form a projection.

During the transition from (1) to (2) in FIG. 19, the flying posture of the head is substantially unchanged. Only the spacing between the magnetic pole portion of the head and the magnetic disk is reduced by the thermal expansion of the head. On the other hand, during the transition from (2) to (3) in FIG. 19, the flying posture changes due to the thermal expansion of the head (i.e. The more the head thermally expands, the smaller the pitch angle becomes).

In this situation, when it is assumed that the reading element of the head is positioned slightly on the flow-in side of the apex of the projection-like swelling formed on the magnetic pole tip of the head due to the thermal expansion, the reading element of the head and the magnetic disk have a positional relationship with each other so that the spacing between them has a tendency to slightly decrease, because the pitch angle becomes smaller as the head thermally expands. With this example of assumption and observation, it is possible to explain, without any logical contradiction, the situation where the read amplitude does not start, for a long time, to have a decreasing tendency even after the thermal expansion has continued for a while.

As explained so far, in the magnetic recording apparatus 300 according to the third embodiment, the read/write processing unit 380a writes, in advance, the detection target signal that includes the predetermined frequency component onto the magnetic disk 360. The contact-detection processing unit 380b controls the electric-current controlling unit 380c and the driver controlling unit 380d so that the detection target signal is read while the spacing between the head 350 and the magnetic disk 360 is changed by the regular increments. When the amount of change in the amplitude of the predetermined frequency component in the read detection target signal becomes smaller than the threshold value, it is judged that the head 350 has made contact with the magnetic disk 360, and thus the contact of the head 350 is detected. Consequently, it is possible to accurately detect the contact of the head 350 with the magnetic disk 360.

Also, according to the third embodiment, the contact of the head 350 is detected by focusing on the amount of change in the amplitude of the read detection target signal. Thus, it is possible to accurately detect the contact of the head 350, even if the amplitude of the signal keeps increasing.

Next, the technical features of a magnetic recording apparatus according to a fourth embodiment of the present invention will be explained. The magnetic recording apparatus according to the fourth embodiment writes, in advance, a signal pattern including a predetermined frequency component (for example, 111111 or 111100) onto a magnetic disk at a predetermined frequency (for example, 100 MHz). In the following description, the signal pattern (the signal including the predetermined frequency component) written onto the magnetic disk at the predetermined frequency (or at the predetermined frequencies) will be referred to as “detection target signal”, like in the description of the first embodiment.

To detect contact of the head with the magnetic disk, the magnetic recording apparatus decreases the spacing between the head and the magnetic disk by causing the magnetic pole tip of the head to thermally expand, using electric current (i.e. heating the magnetic pole tip with a heater), and reads the amplitude of the predetermined frequency component in the detection target signal recorded on the magnetic disk. When the proportion of the change in the read amplitude (i.e. the ratio of “the amount of change in the read amplitude” to “the amount of change in the spacing between the head and the magnetic disk under the control”) becomes equal to or larger than a threshold value, it is judged that the head has made contact with the magnetic disk, and thus the contact of the head is detected.

As explained above, the magnetic recording apparatus according to the fourth embodiment decreases the spacing between the head and the magnetic disk by heating the magnetic pole tip of the head with the heater and reads the amplitude of the predetermined frequency component in the detection target signal recorded on the magnetic disk. When the proportion of the change in the amplitude becomes equal to or larger than the threshold value, it is judged that the head has made contact with the magnetic disk, and thus the contact of the head with the magnetic disk is detected. Consequently, it is possible to accurately detect whether the head is in or out of contact with the magnetic disk, even if the amplitude of the component does not clearly start to show a decrease.

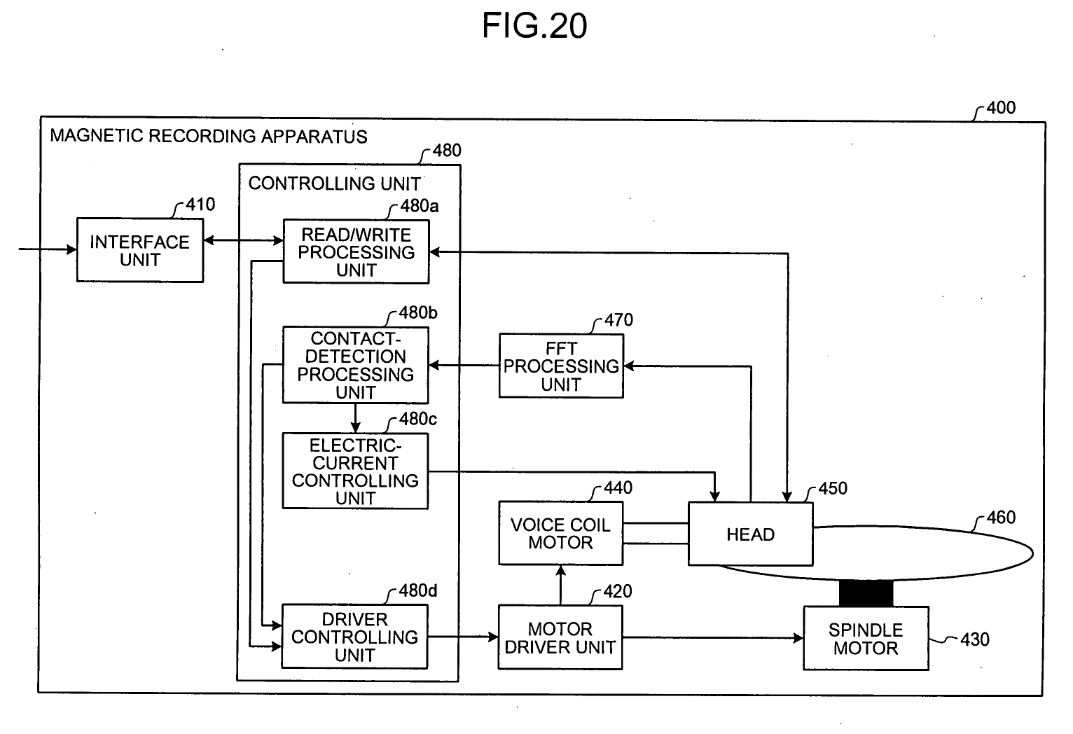

Next, a configuration of the magnetic recording apparatus according to the fourth embodiment will be explained. FIG. 20 is a functional block diagram of a magnetic recording apparatus 400 according to the fourth embodiment. The magnetic recording apparatus 400 includes an interface unit 410, a motor driver unit 420, a spindle motor 430, a voice coil motor 440, a head 450, a magnetic disk 460, an FFT processing unit 470, and a controlling unit 480.

The interface unit 410, the motor driver unit 420, the spindle motor 430, the voice coil motor 440, the head 450, the magnetic disk 460, the FFT processing unit 470 are respectively the same as the interface unit 110, the motor driver unit 130, the spindle motor 140, the voice coil motor 150, the head 160, the magnetic disk 170, and the FFT processing unit 180. Therefore, the explanation of these elements will be omitted.

The controlling unit 480 controls the writing and the reading of data to and from the magnetic disk 460, and also detects contact of the head 450 with the magnetic disk 460. The controlling unit 480 includes a read/write processing unit 480a, a contact-detection processing unit 480b, an electric-current controlling unit 480c, and a driver controlling unit 480d.

The read/write processing unit 480a performs the writing and the reading of data to and from the magnetic disk 460 according to a write request or a read request from the host computer. The read/write processing unit 480a also writes the signal pattern (111111 or 111100) onto the magnetic disk 460 at a predetermined frequency (or at various frequencies) according to an instruction from the host computer.

The contact-detection processing unit 480b detects contact of the head with the magnetic disk 460. More specifically, the contact-detection processing unit 480b controls the electric-current controlling unit 480c and the driver controlling unit 480d and reads the detection target signal while decreasing the spacing between the head 450 and the magnetic disk 460. The contact-detection processing unit 480b detects the contact of the head, based on the proportion of the change (i.e. the gradient) in the amplitude of the predetermined frequency component in the read detection target signal.

Using electric current, the electric-current controlling unit 480c adjusts the spacing between the head 450 and the magnetic disk 460 by causing a magnetic pole tip of the head 450 to generate heat and expand. According to the fourth embodiment, to allow the contact-detection processing unit 480b to detect the contact of the head, the electric-current controlling unit 480c supplies electric current to the magnetic pole tip of the head 450 so that the spacing between the head 450 and the magnetic disk 460 is decreased.

Upon receiving notification from the contact-detection processing unit 480b that the head 450 has made contact, the electric-current controlling unit 480c stops the electric current supply to the head 450 to cause the magnetic pole tip of the head 450 to contract. With this arrangement, it is possible to efficiently reduce the head vibrations that are caused when the head 450 makes contact with the magnetic disk 460. The explanation of the configuration of the head 450 is the same as the explanation of the configuration of the head 160 shown in FIG. 4. Thus, the explanation of the head 450 will be omitted.

The driver controlling unit 480d outputs an instruction to the motor driver unit 420 and controls the spindle motor 430 and the voice coil motor 440.

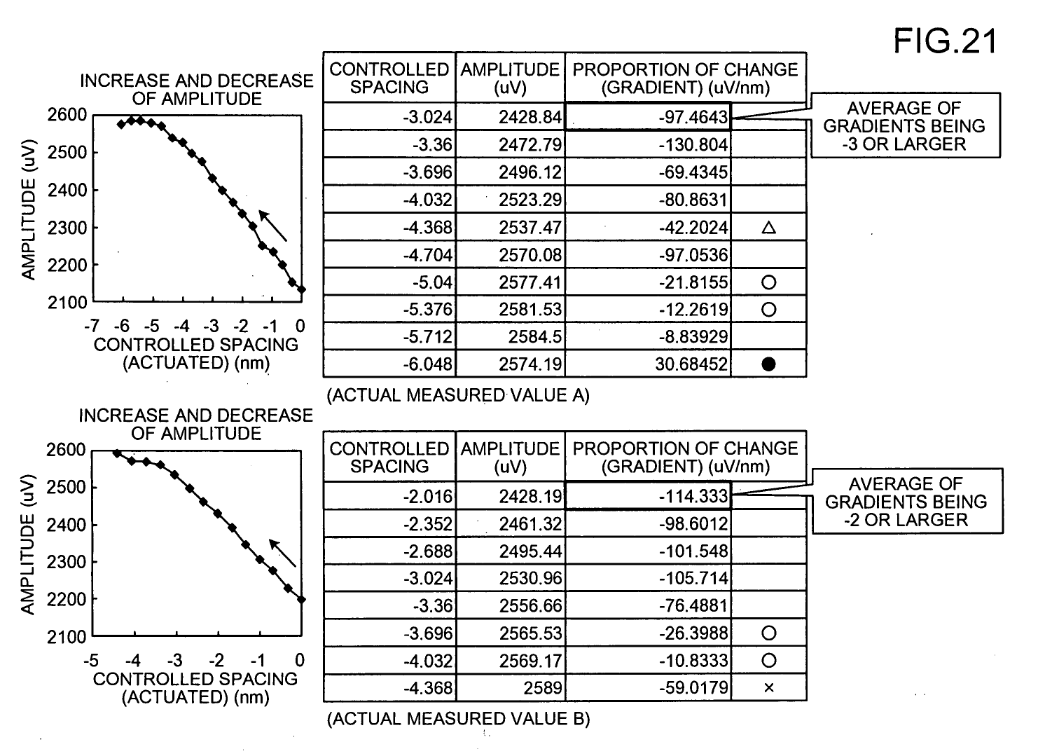

Next, the proportion of the change (the gradient) in the amplitude of the detection target signal when the spacing between the head 450 and the magnetic disk 460 under the control (hereinafter, “the controlled spacing”) is decreased will be explained. FIG. 21 illustrates graphs and charts for explaining the proportion of the change in the amplitude of the detection target signal.

The contact-detection processing unit 480b decreases the controlled spacing and calculates, in advance, the average value of the proportions of the change (the gradients) in the amplitude of the signal between the measuring points. The contact-detection processing unit 480b detects the contact of the head 450 by comparing the proportion of the change between the measuring points with a threshold value defined based on the average value.

The threshold value may be defined using any method. According to the fourth embodiment, however, the threshold value is defined by multiplying the average value by a predetermined value (a predetermined value between 0 and 1). In the upper section in FIG. 21 (the actual measured value A), the average value of the proportions of the change is “−96.4643”. When the predetermined value used for defining the threshold value is “0.5”, for example, the threshold value is defined as “−48.23215”. The contact-detection processing unit 480b compares the proportion of the change between the measuring points with the threshold value. When the proportion of the change becomes equal to or larger than the threshold value, the contact-detection processing unit 480b judges that the head 450 has made contact with the magnetic disk 460. After detecting the contact, the contact-detection processing unit 480b notifies the electric-current controlling unit 480c that the head 450 has made contact.

In the upper section in FIG. 21, the “proportion of the change” that is equal to or larger than the threshold value is detected at the point with the controlled spacing “−4.368 nm” and also at the point with the controlled spacing “−5.04 nm” and all the points underneath. Because the point with the controlled spacing “−4.368 nm” is one point that is isolated from the other points having a larger proportion of the change, this point is considered as a noise in the measurement. Accordingly, when two or more points in a row have a value of “the proportion of the change” that is equal to or larger than the threshold value, the contact-detection processing unit 480b judges that the head 450 has made contact with the magnetic disk 460. In the upper section in FIG. 21, the point with the controlled spacing “−5.04 nm” is considered as the contact starting point.

In the example shown in the lower section in FIG. 21 (i.e. the actual measured value B), the average value of the proportions of the change is “−114.333”. When the predetermined value used for defining the threshold value is “0.5”, for example, the threshold value is defined as “−57.1665”. The contact-detection processing unit 480b compares the proportion of the change between the measuring points with the threshold value. When the proportion of the change becomes equal to or larger than the threshold value, the contact-detection processing unit 480b judges that the head 450 has made contact with the magnetic disk 460. In the lower section in FIG. 21, the point with the controlled spacing “−3.696 nm” is considered as the contact starting point.

As explained above, in the magnetic recording apparatus 400 according to the fourth embodiment, the read/write processing unit 480a writes, in advance, the detection target signal that includes the predetermined frequency component onto the magnetic disk 460. The contact-detection processing unit 480b controls the electric-current controlling unit 480c and the driver controlling unit 480d so that the detection target signal is read while the spacing between the head 450 and the magnetic disk 460 is changed. When the proportion of the change in the amplitude of the predetermined frequency component in the read detection target signal becomes equal to or larger than the threshold value, it is judged that the head 450 has made contact with the magnetic disk 460, and thus the contact of the head 450 is detected. Consequently, it is possible to accurately detect the contact of the head 450 with the magnetic disk 460.

Also, according to the fourth embodiment, the contact of the head 450 is detected by focusing on the proportion of the change in the read detection target signal. Thus, it is possible to accurately detect the contact of the head 450, even if the amplitude of the signal keeps increasing.

Next, the technical features of a magnetic recording apparatus according to a fifth embodiment of the invention will be explained. The magnetic recording apparatus according to the fifth embodiment writes, in advance, a signal pattern including a predetermined frequency component (for example, 111111 or 111100) onto a magnetic disk at a predetermined frequency (for example, 100 MHz). In the following description, the signal pattern (the signal including the predetermined frequency component) written onto the magnetic disk at the predetermined frequency (or at the predetermined frequencies) will be referred to as “detection target signal”, like in the description of the first embodiment.

To detect contact of the head with the magnetic disk, the magnetic recording apparatus decreases the spacing between the head and the magnetic disk by causing the magnetic pole tip of the head to thermally expand, using electric current (i.e. heating the magnetic pole tip with a heater), reads the amplitude of the predetermined frequency component in the detection target signal recorded on the magnetic disk, and converts the read amplitude of the signal into the spacing between the head and the magnetic disk. When the proportion of the change with respect to the converted spacing (i.e. the ratio of “the amount of change in the spacing converted from the amplitude of the signal” to “the amount of change in the spacing under the control”) becomes smaller than a threshold value, it is judged that the head has made contact with the magnetic disk, and thus the contact of the head is detected.

As explained above, the magnetic recording apparatus according to the fifth embodiment decreases the spacing between the head and the magnetic disk by heating the magnetic pole tip of the head with the heater, reads the amplitude of the predetermined frequency component in the detection target signal recorded on the magnetic disk, and converts the read amplitude of the signal into the spacing between the head and the magnetic disk. When the proportion of the change with respect to the converted spacing becomes smaller than the threshold value, it is judged that the head has made contact with the magnetic disk, and thus the contact of the head with the magnetic disk is detected. Consequently, it is possible to accurately detect whether the head is in or out of contact with the magnetic disk, even if the amplitude of the component does not clearly start to show a decrease.

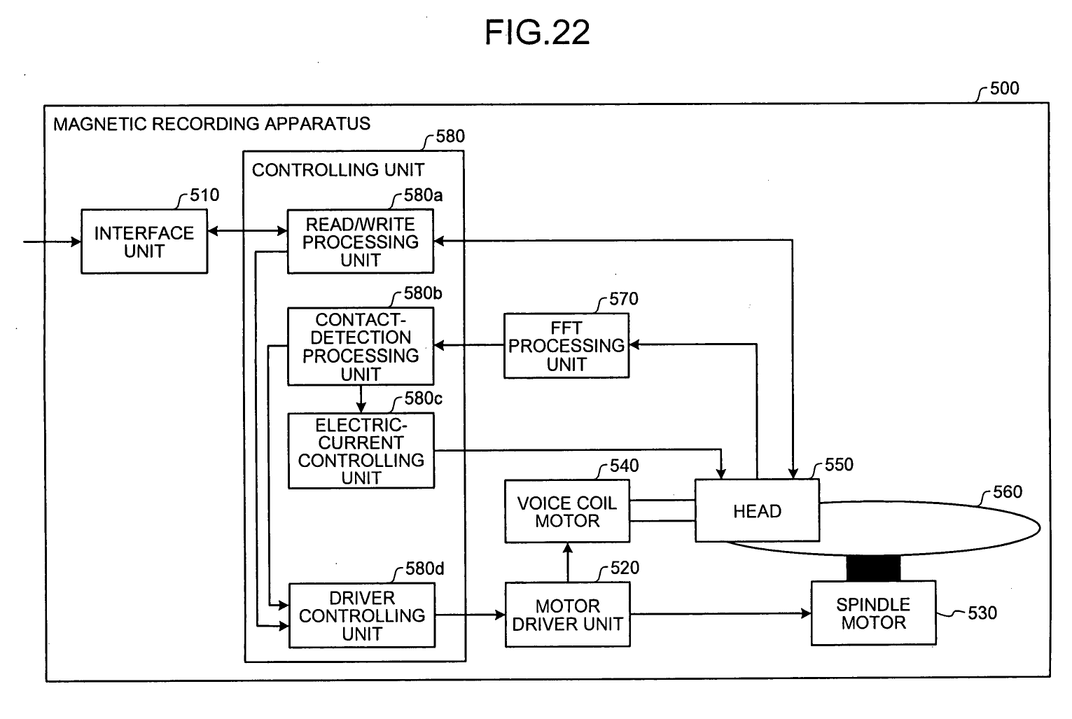

Next, a configuration of the magnetic recording apparatus according to the fifth embodiment will be explained. FIG. 22 is a functional block diagram of a magnetic recording apparatus 500 according to the fifth embodiment. The magnetic recording apparatus 500 includes an interface unit 510, a motor driver unit 520, a spindle motor 530, a voice coil motor 540, a head 550, a magnetic disk 560, an FFT processing unit 570, and a controlling unit 580.

The interface unit 510, the motor driver unit 520, the spindle motor 530, the voice coil motor 540, the head 550, the magnetic disk 560, the FFT processing unit 570 are respectively the same as the interface unit 110, the motor driver unit 130, the spindle motor 140, the voice coil motor 150, the head 160, the magnetic disk 170, and the FFT processing unit 180 that are shown in FIG. 2. Therefore, the explanation of these elements will be omitted.

The controlling unit 580 controls the writing and the reading of data to and from the magnetic disk 560, and also detects contact of the head 550 with the magnetic disk 560. The controlling unit 580 includes a read/write processing unit 580a, a contact-detection processing unit 580b, an electric-current controlling unit 580c, and a driver controlling unit 580d.

The read/write processing unit 580a performs the writing and the reading of data to and from the magnetic disk 560 according to a write request or a read request from the host computer. The read/write processing unit 580a also writes the signal pattern (111111 or 111100) onto the magnetic disk 560 at a predetermined frequency (or at various frequencies) according to an instruction from the host computer.

The contact-detection processing unit 580b detects contact of the head with the magnetic disk 560. More specifically, the contact-detection processing unit 580b controls the electric-current controlling unit 580c and the driver controlling unit 580d, reads the detection target signal while decreasing the spacing between the head 550 and the magnetic disk 560, and converts the read amplitude of the detection target signal into a value of the spacing between the head 550 and the magnetic disk 560. The contact-detection processing unit 580b detects the contact of the head, based on the proportion of the change with respect to the converted spacing. The specific formula used for converting the amplitude of the detection target signal into the value of the spacing between the head 550 and the magnetic disk 560 is the same as Equation (1) according to the first embodiment; therefore, the explanation thereof will be omitted.

Using electric current, the electric-current controlling unit 580c adjusts the spacing between the head 550 and the magnetic disk 560 by causing a magnetic pole tip of the head 550 to generate heat and expand. According to the fifth embodiment, to allow the contact-detection processing unit 580b to detect the contact of the head, the electric-current controlling unit 580c supplies electric current to the magnetic pole tip of the head 550 so that the spacing between the head 550 and the magnetic disk 560 is decreased.

Upon receiving notification from the contact-detection processing unit 580b that the head 550 has made contact, the electric-current controlling unit 580c stops the electric current supply to the head 550 to cause the magnetic pole tip of the head 550 to contract. With this arrangement, it is possible to efficiently reduce the head vibrations that are caused when the head 550 makes contact with the magnetic disk 560. The explanation of the configuration of the head 550 is the same as the explanation of the configuration of the head 160 shown in FIG. 4. Thus, the explanation of the head 550 will be omitted.

The driver controlling unit 580d outputs an instruction to the motor driver unit 520 and controls the spindle motor 530 and the voice coil motor 540.

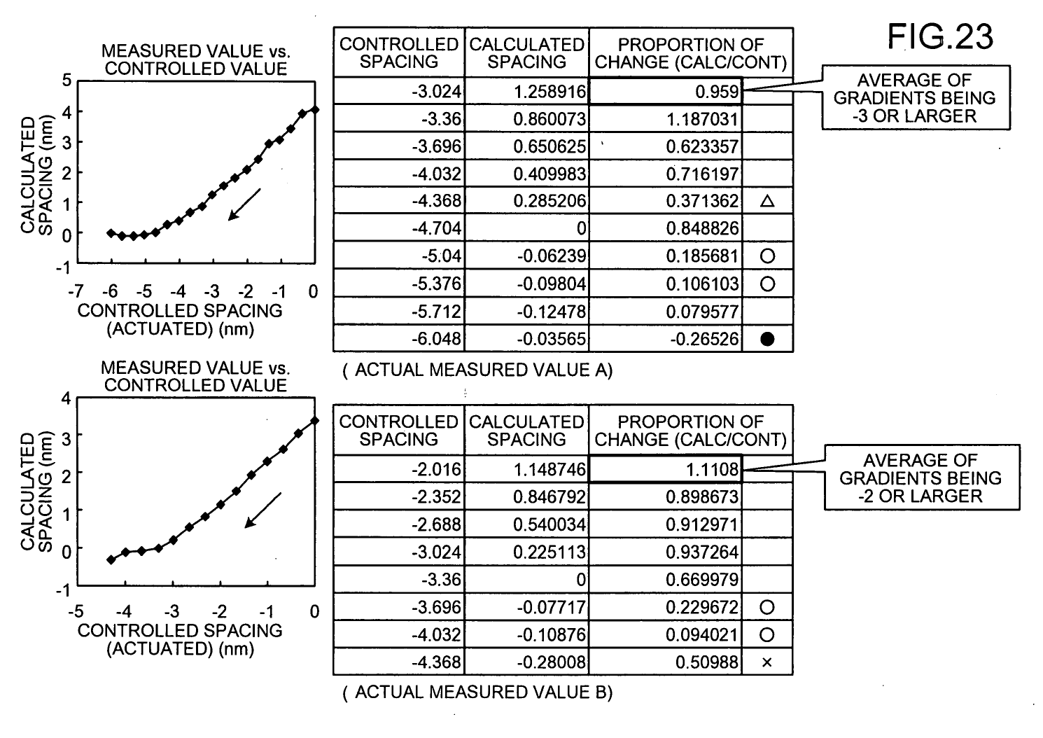

Next, the relationship between the spacing between the head 550 and the magnetic disk 560 under the control (hereinafter, “the controlled spacing”) and the spacing calculated using the amplitude (of the predetermined frequency component) in the detection target signal read from the magnetic disk 560 (hereinafter, “the calculated spacing”) will be explained. FIG. 23 illustrates graphs and charts for explaining the relationship between the controlled spacing and the calculated spacing according to the fifth embodiment.

The contact-detection processing unit 580b decreases the controlled spacing and calculates, in advance, the average value of the proportions of the change (the gradients) of the calculated spacing between the measuring points. The contact-detection processing unit 580b then detects the contact of the head 550 by comparing the proportion of the change between the measuring points with a threshold value defined based on the average value.

The threshold value may be defined using any method. According to the fifth embodiment, however, the threshold value is defined by multiplying the average value by a predetermined value (a predetermined value between 0 and 1). In the upper section in FIG. 23 (the actual measured value A), the average value of the proportions of the change is “0.959”. When the predetermined value used for defining the threshold value is “0.5”, for example, the threshold value is defined as “0.4795”. The contact-detection processing unit 580b compares the proportion of the change between the measuring points with the threshold value. When the proportion of the change becomes smaller than the threshold value, the contact-detection processing unit 580b judges that the head 550 has made contact with the magnetic disk 560. After detecting the contact, the contact-detection processing unit 580b notifies the electric-current controlling unit 580c that the head 550 has made contact.

In the upper section in FIG. 23, the “proportion of the change” that is smaller than the threshold value is detected at the point with the controlled spacing “−4.368 nm” and also at the point with the controlled spacing “−5.04 nm” and all the points underneath. Because the point with the controlled spacing “−4.368 nm” is one point that is isolated from the other points having a smaller proportion of the change, this point is considered as a noise in the measurement. Accordingly, when two or more points in a row have a value of “the proportion of the change” that is smaller than the threshold value, the contact-detection processing unit 580b judges that the head 550 has made contact with the magnetic disk 560. In the upper section in FIG. 23, the point with the controlled spacing “−5.04 nm” is considered as the contact starting point.

In the example shown in the lower section in FIG. 23 (i.e. the actual measured value B), the average value of the proportions of the change is “1.1108”. When the predetermined value used for defining the threshold value is “0.5”, for example, the threshold value is defined as “−0.5554”. The contact-detection processing unit 580b compares the proportion of the change between the measuring points with the threshold value. When the proportion of the change becomes smaller than the threshold value, the contact-detection processing unit 580b judges that the head 550 has made contact with the magnetic disk 560. In the lower section in FIG. 23, the point with the controlled spacing “−6.048 nm” is considered as the contact starting point.

In the example shown in the lower section in FIG. 23 (the actual measured value B), because there is no measuring point at which the proportion of the change is reversed, it is not possible to detect the contact of the head using the detection method disclosed in Japanese Examined Patent Application Publication No. H7-1618.

As explained above, in the magnetic recording apparatus 500 according to the fifth embodiment, the read/write processing unit 580a writes, in advance, the detection target signal that includes the predetermined frequency component onto the magnetic disk 560. The contact-detection processing unit 580b controls the electric-current controlling unit 580c and the driver controlling unit 580d so that the detection target signal is read while the spacing between the head 550 and the magnetic disk 560 is changed, and the read amplitude of the detection target signal is converted into a calculated spacing. When the proportion of the change in the calculated spacing becomes smaller than the threshold value, the contact-detection processing unit 580b judges that the head 550 has made contact with the magnetic disk 560, and thus the contact of the head 550 is detected. Consequently, it is possible to accurately detect the contact of the head 550 with the magnetic disk 560.

The magnetic recording apparatus 500 according to the fifth embodiment detects the contact of the head by focusing on the proportion of the change (the gradient) in the calculated spacing; however, the present invention is not limited to this example. For example, it is acceptable to make the position of the head 550 closer to the magnetic disk 560 by a regular proportion so as to focus on the amount of change in the calculated spacing. In this example, when the amount of change (the difference) in the calculated spacing becomes smaller than a threshold value, it is judged that the head 550 has made contact with the magnetic disk 560, and thus the contact of the head 550 is detected.

Next, the technical features of a magnetic recording apparatus according to a sixth embodiment of the invention will be explained. The magnetic recording apparatus according to the sixth embodiment writes, in advance, a signal pattern including predetermined frequency components (for example, 111100) onto a magnetic disk at a predetermined frequency (for example, 100 MHz). In the following description, the signal pattern (the signal including the predetermined frequency components) written onto the magnetic disk at the predetermined frequency will be referred to as “detection target signal”, like in the description of the first embodiment.

To detect contact of the head with the magnetic disk, the magnetic recording apparatus decreases the spacing between the head and the magnetic disk by causing the magnetic pole tip of the head to thermally expand, using electric current (i.e. heating the magnetic pole tip with a heater), reads the amplitudes of the predetermined frequency components (the first-order frequency component and the third-order frequency component, according to the sixth embodiment) in the detection target signal recorded on the magnetic disk, and calculates the spacing between the head and the magnetic disk, based on the amplitudes of the frequency components in the read signal. When the proportion of the change with respect to the spacing obtained as a result of the calculation (hereinafter, the “calculated spacing”) becomes smaller than a threshold value, it is judged that the head has made contact with the magnetic disk, and thus the contact of the head is detected.

As explained above, the magnetic recording apparatus according to the sixth embodiment decreases the spacing between the head and the magnetic disk by heating the magnetic pole tip of the head with the heater, reads the amplitudes of the predetermined frequency components in the detection target signal recorded on the magnetic disk, and calculates the calculated spacing based on the amplitudes of the frequency components (the first-order frequency component and the third-order frequency component) in the read signal. When the proportion of the change corresponding to the calculated spacing (the ratio of the amount of change in the calculated spacing to the amount of change in the controlled spacing) becomes smaller than the threshold value, it is judged that the head has made contact with the magnetic disk, and thus the contact of the head with the magnetic disk is detected. Consequently, it is possible to accurately detect whether the head is in or out of contact with the magnetic disk, even if the amplitude of the component does not clearly start to show a decrease.

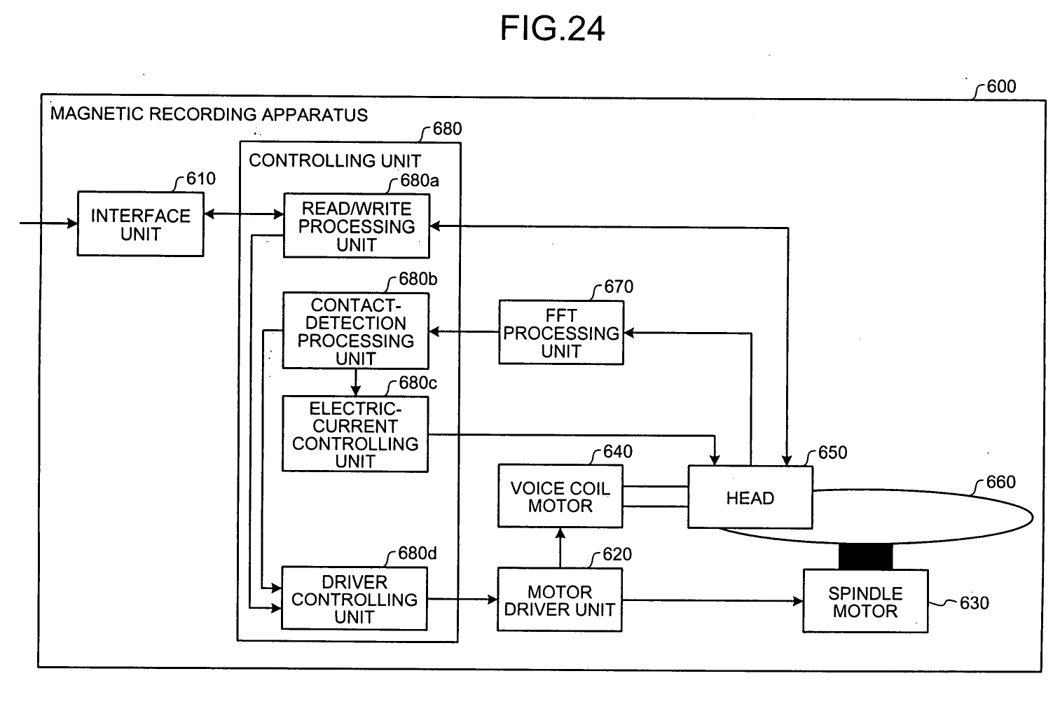

Next, a configuration of the magnetic recording apparatus according to the sixth embodiment will be explained. FIG. 24 is a functional block diagram of the magnetic recording apparatus according to the sixth embodiment. As shown in the drawing, a magnetic recording apparatus 600 includes an interface unit 610, a motor driver unit 620, a spindle motor 630, a voice coil motor 640, a head 650, a magnetic disk 660, an FFT processing unit 670, and a controlling unit 680.

The explanation of the interface unit 610, the motor driver unit 620, the spindle motor 630, the voice coil motor 640, the head 650, the magnetic disk 660, the FFT processing unit 670 is the same as the explanation of the interface unit 110, the motor driver unit 130, the spindle motor 140, the voice coil motor 150, the head 160, the magnetic disk 170, and the FFT processing unit 180 that are shown in FIG. 2. Thus, the explanation of these elements will be omitted.

The controlling unit 680 controls the writing and the reading of data to and from the magnetic disk 660, and also detects contact of the head 650 with the magnetic disk 660. The controlling unit 680 includes a read/write processing unit 680a, a contact-detection processing unit 680b, an electric-current controlling unit 680c, and a driver controlling unit 680d.

The read/write processing unit 680a performs the writing and the reading of data to and from the magnetic disk 660 according to a write request or a read request from the host computer. The read/write processing unit 680a also writes the signal pattern (for example, 111111) onto the magnetic disk 660 at a predetermined frequency (or at various frequencies) according to an instruction from the host computer.

The contact-detection processing unit 680b detects contact of the head with the magnetic disk 660. More specifically, the contact-detection processing unit 680b controls the electric-current controlling unit 680c and the driver controlling unit 680d, reads the detection target signal while decreasing the spacing between the head 650 and the magnetic disk 660, and calculates the spacing between the head 650 and the magnetic disk 660, based on the amplitudes of the frequency components in the read detection target signal. The contact-detection processing unit 680b detects the contact of the head, based on the proportion of the change with respect to the calculated spacing.

The specific formula used for calculating the calculated spacing based on the amplitudes of the frequency components (the first-order frequency component and the third-order frequency component) in the detection target signal is shown below:

$$Δ ( d + a ) = \frac{3 {λ}_{3}}{4 π} ln [ \frac{( {V}_{3} / {V}_{1} )}{{( {V}_{3} / {V}_{1} )}_{ref}} ] \qquad ( 4 )$$

The explanation of the symbols used in Equation (4) is the same as the explanation of the symbols used in Equation (3) according to the second embodiment; therefore, the explanation of these symbols will be omitted. The contact-detection processing unit 680b is able to convert “the change in the amplitudes” into “the change in the spacing” by using Equation (4), based on the ratio between the amplitude of the first-order component and the amplitude of the third-order component.

Using electric current, the electric-current controlling unit 680c adjusts the spacing between the head 650 and the magnetic disk 660 by causing a magnetic pole tip of the head 650 to generate heat and expand. According to the sixth embodiment, to allow the contact-detection processing unit 680b to detect the contact of the head, the electric-current controlling unit 680c supplies electric current to the magnetic pole tip of the head 650 so that the spacing between the head 650 and the magnetic disk 660 is decreased.

Upon receiving notification from the contact-detection processing unit 680b that the head 650 has made contact, the electric-current controlling unit 680c stops the electric current supply to the head 650 to cause the magnetic pole tip of the head 650 to contract. With this arrangement, it is possible to efficiently reduce the head vibrations that are caused when the head 650 makes contact with the magnetic disk 660. The explanation of the configuration of the head 650 is the same as the explanation of the configuration of the head 160 shown in FIG. 4. Thus, the explanation of the head 550 will be omitted.

The driver controlling unit 680d outputs an instruction to the motor driver unit 620 and controls the spindle motor 630 and the voice coil motor 640.

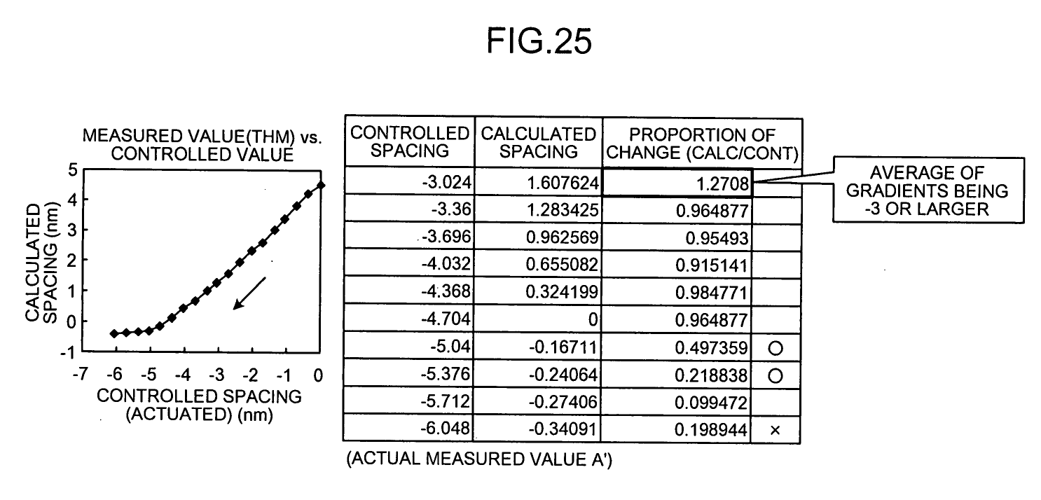

Next, the relationship between the spacing between the head 650 and the magnetic disk 660 under the control (hereinafter, “the controlled spacing”) and the spacing calculated using the amplitudes (of the first-order frequency component and the third-order frequency component) in the detection target signal read from the magnetic disk 660 (hereinafter, “the calculated spacing”) will be explained. FIG. 25 illustrates a graphs and a chart for explaining the relationship between the controlled spacing and the calculated spacing according to the sixth embodiment.

The contact-detection processing unit 680b decreases the controlled spacing and calculates, in advance, the average value of the proportions of the change (the gradients) of the calculated spacing between the measuring points. The contact-detection processing unit 680b detects the contact of the head 650 by comparing the proportion of the change between the measuring points with a threshold value defined based on the average value.

The threshold value may be defined using any method. According to the sixth embodiment, however, the threshold value is defined by multiplying the average value by a predetermined value (a predetermined value between 0 and 1). In FIG. 25 (the actual measured value A′), the average value of the proportions of the change is “1.2708”. When the predetermined value used for defining the threshold value is “0.5”, for example, the threshold value is defined as “0.6354”. The contact-detection processing unit 680b compares the proportion of the change between the measuring points with the threshold value. When the proportion of the change becomes smaller than the threshold value, the contact-detection processing unit 680b judges that the head 650 has made contact with the magnetic disk 660.

In the example shown in FIG. 25, the proportion of change that is smaller than the threshold value is detected at the point with the controlled spacing “−5.04 nm” and also at all the points underneath. Accordingly, in the example shown in FIG. 25, the point with the controlled spacing “−5.04 nm” is considered as the contact starting point. After detecting the contact, the contact-detection processing unit 680b notifies the electric-current controlling unit 680c that the head 650 has made contact.

As explained above, in the magnetic recording apparatus 600 according to the sixth embodiment, the read/write processing unit 680a writes, in advance, the detection target signal that includes the predetermined frequency components onto the magnetic disk 660. The contact-detection processing unit 680b controls the electric-current controlling unit 680c and the driver controlling unit 680d so that the detection target signal is read while the spacing between the head 650 and the magnetic disk 660 is changed, and the calculated spacing is calculated based on the amplitudes (of the first-order frequency component and the third-order frequency component) in the read detection target signal. When the proportion of the change in the calculated spacing becomes smaller than the threshold value, the contact-detection processing unit 680b judges that the head 650 has made contact with the magnetic disk 660, and thus the contact of the head 650 is detected. Consequently, it is possible to accurately detect the contact of the head 650 with the magnetic disk 660.

The magnetic recording apparatus 600 according to the sixth embodiment detects the contact of the head by focusing on the proportion of the change (the gradient) in the calculated spacing; however, the present invention is not limited to this example. For example, it is acceptable to make the position of the head 650 closer to the magnetic disk 660 by a regular proportion so as to focus on the amount of change in the calculated spacing. In this example, when the amount of change (the difference) in the calculated spacing becomes smaller than a threshold value, it is judged that the head 650 has made contact with the magnetic disk 660, and thus the contact of the head 650 is detected.

Next, the technical features of a magnetic recording apparatus according to a seventh embodiment of the invention will be explained. The magnetic recording apparatus according to the seventh embodiment writes, in advance, a signal pattern including a predetermined frequency component (for example, 111111 or 111100) onto a magnetic disk at a predetermined frequency (for example, 100 MHz). In the following description, the signal pattern written onto the magnetic disk at the predetermined frequency (or at the predetermined frequencies) will be referred to as “detection target signal”, like in the description of the first embodiment.

To detect contact of the head with the magnetic disk, the magnetic recording apparatus causes the magnetic pole tip of the head to thermally expand, using electric current (i.e. heating the magnetic pole tip with a heater), reads the amplitude of the predetermined frequency component in the detection target signal recorded on the magnetic disk while adjusting the spacing between the head and the magnetic disk (i.e. while gradually decreasing the spacing by regular increments), and smoothes the read amplitude. When the amount of change in the amplitude that has been smoothed becomes smaller than a threshold value, it is judged that the head has made contact with the magnetic disk, and thus the contact of the head is detected.

As explained above, the magnetic recording apparatus according to the seventh embodiment decreases the spacing between the head and the magnetic disk by the regular increments by heating the magnetic pole tip of the head with the heater, reads the amplitude of the predetermined frequency component in the detection target signal recorded on the magnetic disk, and smoothes the read amplitude. When the amount of change in the amplitude that has been smoothed becomes smaller than the threshold value, it is judged that the head has made contact with the magnetic disk, and thus the contact of the head with the magnetic disk is detected. Consequently, it is possible to accurately detect whether the head is in or out of contact with the magnetic disk, without being affected by an occurrence of noise.

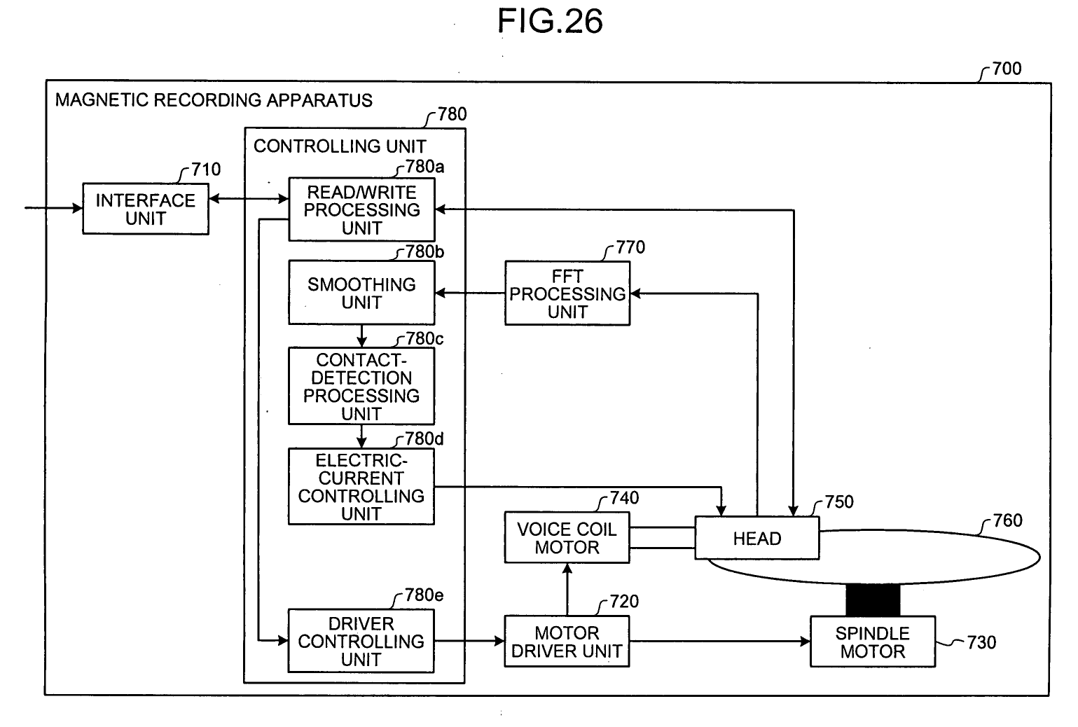

Next, a configuration of the magnetic recording apparatus according to the seventh embodiment will be explained. FIG. 26 is a functional block diagram of a magnetic recording apparatus 700 according to the seventh embodiment. The magnetic recording apparatus 700 includes an interface unit 710, a motor driver unit 720, a spindle motor 730, a voice coil motor 740, a head 750, a magnetic disk 760, an FFT processing unit 770, and a controlling unit 780.

The explanation of the interface unit 710, the motor driver unit 720, the spindle motor 730, the voice coil motor 740, the head 750, the magnetic disk 760, the FFT processing unit 770 is the same as the explanation of the interface unit 110, the motor driver unit 130, the spindle motor 140, the voice coil motor 150, the head 160, the magnetic disk 170, and the FFT processing unit 180 that are shown in FIG. 2. Thus, the explanation of these elements will be omitted.

The controlling unit 780 controls the writing and the reading of data to and from the magnetic disk 760, and also detects contact of the head 750 with the magnetic disk 760. The controlling unit 780 includes a read/write processing unit 780a, a smoothing unit 780b, a contact-detection processing unit 780c, an electric-current controlling unit 780d, and a driver controlling unit 780e.

The read/write processing unit 780a performs the writing and the reading of data to and from the magnetic disk 760 according to a write request or a read request from the host computer. The read/write processing unit 780a also writes the signal pattern (111111 or 111100) onto the magnetic disk 760 at a predetermined frequency (or at various frequencies) according to an instruction from the host computer.

The smoothing unit 780b smoothes the amplitude of the detection target signal. The amplitude may be smoothed using any method. According to the seventh embodiment, however, the amplitude is smoothed using a three-point moving average filter. If the source data has less than three points at the terminal points of a section, the average of two points is used. The smoothing unit 780b outputs the information of the smoothed amplitude to the contact-detection processing unit 780c.

The contact-detection processing unit 780c detects contact of the head with the magnetic disk 760. More specifically, the contact-detection processing unit 780c controls the electric-current controlling unit 780d and the driver controlling unit 780e, changes the spacing between the head 750 and the magnetic disk 760 by regular increments, and detects contact of the head, based on the amount of change in the amplitude that has been smoothed by the smoothing unit 780b.

Using electric current, the electric-current controlling unit 780d adjusts the spacing between the head 750 and the magnetic disk 760 by causing a magnetic pole tip of the head 750 to generate heat and expand. According to the seventh embodiment, to allow the contact-detection processing unit 780c to detect the contact of the head, the electric-current controlling unit 780d supplies electric current to the magnetic pole tip of the head 750 so that the spacing between the head 750 and the magnetic disk 760 is decreased by the predetermined proportion.

Upon receiving notification from the contact-detection processing unit 780c that the head 750 has made contact, the electric-current controlling unit 780d stops the electric current supply to the head 750 to cause the magnetic pole tip of the head 750 to contract. With this arrangement, it is possible to efficiently reduce the head vibrations that are caused when the head 750 makes contact with the magnetic disk 760. The explanation of the configuration of the head 750 is the same as the explanation of the configuration of the head 160 shown in FIG. 4. Thus, the explanation of the head 550 will be omitted.

The driver controlling unit 780e outputs an instruction to the motor driver unit 720 and controls the spindle motor 730 and the voice coil motor 740.

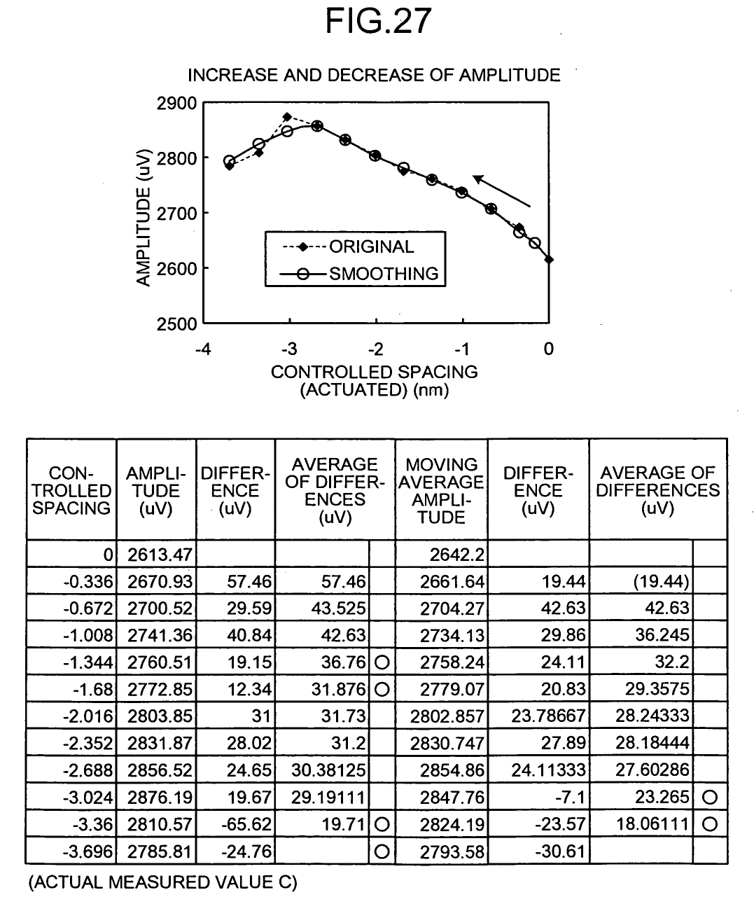

Next, the relationship between the spacing between the head 750 and the magnetic disk 760 under the control (hereinafter, “the controlled spacing”) and the amplitude (of the predetermined frequency component) in the detection target signal read from the magnetic disk 760 will be explained. FIG. 27 illustrates a graph and a chart for explaining the relationship between the controlled spacing and the amplitude of the detection target signal according to the seventh embodiment. In the chart on the right side in FIG. 27, the amplitude that has not been smoothed, the difference in the amplitude, the average of the differences in the amplitude, the amplitude that has been smoothed (hereinafter, “moving average amplitude”), the difference in the moving average amplitude, and the average of the differences in the moving average amplitude are shown. In the present example, the “average of the differences” denotes an accumulated average value of the “difference” values from the measuring start point to each point that is immediately before a measuring point.

The contact-detection processing unit 780c detects the contact of the head 750 by comparing the threshold value defined based on the average of the differences with the amount of change (the difference) in the amplitude at the measuring points. The operation will be explained more specifically with reference to FIG. 27. As for the amplitudes that have not been smoothed, the difference “19.15” for the controlled spacing “−1.344 nm” is compared with the threshold value “21.315”, which is obtained by multiplying the immediately preceding average of the differences “42.63” by a predetermined value (for example, 0.5). The calculated threshold value is compared with each of the differences in this manner. When the difference becomes smaller than the threshold value, it is judged that the head 750 has made contact.

In other words, when the amplitudes that have not been smoothed are used for the detection of contact, it is judged that the head 750 has made contact with the magnetic disk 760 when the controlled spacing is “−1.344”, “−1.68 nm”, “−3.36 nm”, and “−3.696 nm”.

As for the amplitudes that have been smoothed, the difference “24.1” for the controlled spacing “−1.344 nm” is compared with the threshold value “18.1225”, which is obtained by multiplying the immediately preceding average of the differences “36.245” by a predetermined value (for example, 0.5).

In other words, when the amplitudes that have been smoothed are used, it is judged that the head 750 has made contact with the magnetic disk 760 when the controlled spacing is “−3.36 nm” and “−3.696 nm”.

Based on a comprehensive judgment using the graph on the left side in FIG. 27, it is considered most likely that the head 750 has actually made contact with the magnetic disk 760 when the controlled spacing is “−3.36 nm”. In other words, the start of contact observed near the controlled spacing “−1.344 nm”, using the amplitudes that have not been smoothed, is considered to be a result of an error detection affected by an occurrence of noise.

On the other hand, when the amplitudes that have been smoothed are used, the start of contact is observed near the controlled spacing “−3.36 nm”. Thus, it means that the contact of the head is accurately detected without being affected by an occurrence of noise. In addition, it is possible to detect the contact of the head 750 more accurately by estimating the contact starting point using the amplitudes that have been smoothed and then detecting the contact point of the head 750, using the method according to the third embodiment. Alternatively, there is another simple method: When the amplitudes that have been smoothed are used and if there are two or more points in a row that have a “smaller difference value”, there is almost no problem in many cases in considering the second one of the points in a row (the controlled spacing “−3.36 nm” in the example shown in FIG. 27) as the contact starting point.

As explained above, in the magnetic recording apparatus 700 according to the seventh embodiment, the read/write processing unit 780a writes, in advance, the detection target signal that includes the predetermined frequency components onto the magnetic disk 760. The contact-detection processing unit 780c controls the electric-current controlling unit 780d and the driver controlling unit 780e so that the spacing between the head 750 and the magnetic disk 760 is changed with the regular increments. The smoothing unit 780b smoothes the amplitude of the detection target signal. When the amount of change in the smoothed amplitude of the signal becomes smaller than the threshold value, the contact-detection processing unit 780c judges that the head 750 has made contact with the magnetic disk 760, and thus the contact of the head 750 is detected. Consequently, it is possible to accurately detect the contact of the head 750 with the magnetic disk 760, without being affected by aft occurrence of noise.

According to the seventh embodiment, the contact of the head 750 is detected, by focusing on the amount of change in the smoothed amplitude; however, the present invention is not limited to this example. For example, it is acceptable to focus on the proportion of the change in the smoothed amplitude and to detect contact of the head 750 by judging that the head 750 has made contact with the magnetic disk 760 when the proportion of the change becomes smaller than a threshold value.

In addition, it is possible to manufacture a head by including a contact detection process in which contact of a recording medium is detected. The contact detection process includes a step of writing, in advance, a predetermined signal pattern (for example, 111111) onto a magnetic disk at a predetermined frequency (for example, 100 MHz) and a step of detecting contact of the head by reading the amplitude of a predetermined frequency component in the detection target signal recorded on the magnetic disk while decreasing the spacing between the magnetic disk and the head by a predetermined proportion and judging that the head has made contact with the magnetic disk when the read amplitude of the component decreases by an amount larger than a threshold value. Other steps are the same as the steps that are normally included in the manufacturing process of a head; therefore, the explanation thereof will be omitted.

By manufacturing the head using the process including these steps, it is possible to control the flying height of the head from the magnetic disk with a higher degree of precision.

According to an aspect of the present invention, the signal that includes the plurality of frequency components is written onto the recording medium, the written signal is read while the rotation speed of the recording medium is changed, and it is detected whether the head is in or out of contact with the recording medium, based on the read amplitude of the frequency components. Thus, it is possible to make accurate judgment of whether the head is in or out of contact with the recording medium.

Moreover, the signal is read while the spacing between the head and the recording medium is decreased by a regular proportion, and if the amount of change in the amplitude of the predetermined frequency component in the read signal is not within the range defined by the threshold value, it is judged that the head has made contact with the recording medium. Thus, it is possible to make accurate judgment of whether the head is in or out of contact with the recording medium, even if the amplitude of the signal keeps increasing.

Furthermore, the signal is read while the spacing between the head and the recording medium is decreased, and if the proportion of the change in the amplitude of the predetermined frequency component in the signal is not within the range defined by the threshold value, it is judged that the head has made contact with the recording medium. Thus, it is possible to make accurate judgment of whether the head is in or out of contact with the recording medium, even if the proportion of the change in the amplitude keeps increasing or keeps decreasing.

Moreover, the signal written on the recording medium is read while the spacing between the head and the recording medium is changed, and the spacing between the head and the recording medium is calculated based on the amplitude of the predetermined frequency component in the signal. If the proportion of the change with respect to the calculated spacing is not within the range defined by the threshold value, it is judged that the head has made contact with the recording medium. Thus, it is possible to make accurate judgment of whether the head is in or out of contact with the recording medium.

Furthermore, when the contact of the head with the recording medium is detected, the heating of the magnetic pole tip of the head is discontinued. Thus, it is possible to quickly reduce the vibrations or the like that are caused when the head makes contact with the recording medium.

According to another aspect of the present invention, it is possible to make accurate judgment of whether the head is in or out of contact with the magnetic disk. Moreover, defects on the head can be detected precisely. Furthermore, it is possible to quickly stop vibrations caused when the head makes contact with the recording medium.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A contact detecting apparatus that detects contact of a head with a recording medium, the contact detecting apparatus comprising:
a signal writing unit that writes onto the recording medium a signal that includes at least one predetermined frequency component; and
a contact detecting unit that detects contact of the head with the recording medium based on an amplitude of the predetermined frequency component, by reading the signal written on the recording medium while changing a spacing between the head and the recording medium, and generates a detection result.

2. The contact detecting apparatus according to claim 1, wherein
the contact detecting unit reads the signal while decreasing the spacing between the head and the recording medium, and
if a decrease in the amplitude of the predetermined frequency component is larger than a threshold value, the contact detecting unit judges that the head has made contact with the recording medium.

3. The contact detecting apparatus according to claim 1, wherein the contact detecting unit changes the spacing between the head and the recording medium by changing a rotation speed of the recording medium.

4. The contact detecting apparatus according to claim 1, wherein the signal includes a plurality of frequency components including the predetermined frequency component.

5. The contact detecting apparatus according to claim 1, wherein if the amplitude of the predetermined frequency component in the signal becomes lower than a predetermined level, the contact detecting unit judges that the head has made contact with a defect on the recording medium.

6. The contact detecting apparatus according to claim 1, wherein when detecting the spacing between the head and the recording medium, a spacing between the head and the recording medium immediately before the contact detecting unit detects the contact of the head with the recording medium is set as a limit spacing, and the limit spacing is proofread based on a standard limit spacing measured in some other unit.

7. The contact detecting apparatus according to claim 1, wherein the contact detecting unit corrects a limit spacing with a standard spacing value that is obtained in advance using an arbitrarily-selected method, the limit spacing being a spacing between the head and the recording medium immediately before the contact of the head with the recording medium is detected, and calculates a value of the spacing between the head and the recording medium, using the corrected limit spacing.

8. The contact detecting apparatus according to claim 1, further comprising a flying height controlling unit that controls a flying height of the head based on the detection result.

9. The contact detecting apparatus according to claim 8, wherein the flying-height controlling unit corrects a limit spacing with a standard spacing value that is obtained in advance using an arbitrarily-selected method, the limit spacing being a spacing between the head and the recording medium immediately before the contact detecting unit detects the contact of the head with the recording medium, and controls the flying height of the head based on the corrected limit spacing.

10. The contact detecting apparatus according to claim 1, wherein when the contact detecting unit judges that the head has made contact with a defect on the recording medium, the contact detecting unit outputs a notification that the head has made contact with the defect.

11. The contact detecting apparatus according to claim 1, further comprising:
a contact vibration calculating unit that calculates an amplitude of vibration occurring when the head makes contact with the recording medium, based on a wavelength of the signal recorded on the recording medium, and outputs a calculated vibration amplitude.

12. The contact detecting apparatus according to note 1, wherein the contact detecting unit changes the spacing between the head and the recording medium by heating a magnetic pole tip of the head, and causing the magnetic pole tip to expand.

13. The contact detecting apparatus according to claim 1, wherein
the contact detecting unit reads the signal while decreasing the spacing between the head and the recording medium by a regular proportion, and
if an amount of change in the amplitude of the predetermined frequency component in the signal is not within a range defined by a threshold value, the contact detecting unit judges that the head has made contact with the recording medium.

14. The contact detecting apparatus according to claim 1, wherein
the contact detecting unit reads the signal while decreasing the spacing between the head and the recording medium, and
if a proportion of a change in the amplitude of the predetermined frequency component in the signal is not within a range defined by a threshold value, the contact detecting unit judges that the head has made contact with the recording medium.

15. The contact detecting apparatus according to claim 1, wherein
the contact detecting unit includes:
a spacing calculating unit that reads the signal written on the recording medium while changing the spacing between the head and the recording medium and calculates the spacing between the head and the recording medium, based on the amplitude of the predetermined frequency component in the signal; and
a detecting unit that judges that the head has made contact with the recording medium if a proportion of a change with respect to the spacing calculated by the spacing calculating unit is not within a range defined by a threshold value.

16. The contact detecting apparatus according to claim 13, further comprising a heating discontinuing unit that, when the contact detecting unit detects the contact of the head with the recording medium, discontinues the heating of the magnetic pole tip of the head.

17. A method for detecting contact of a head with a recording medium, the method comprising:
writing onto the recording medium, a signal that includes at least one predetermined frequency component; and
detecting the contact of the head with the recording medium based on an amplitude of the predetermined frequency component, by reading the signal written on the recording medium while changing a spacing between the head and the recording medium.

18. A head manufacturing method including detecting contact of a head with a recording medium, wherein the detecting includes
writing onto the recording medium, a signal that includes a predetermined frequency component; and
detecting contact of the head with the recording medium based on an amplitude of the predetermined frequency component in the signal, by reading the signal written on the recording medium while changing a spacing between the head and the recording medium and generating a detection result.
